(19) United States
(12) Patent Application Publication
(10) Pub. No.: US 2022/0331711 A1
(43) Pub. Date: Oct. 20, 2022

(54) INTERACTION SYSTEM

(71) Applicant: KABUSHIKI KAISHA KOBE SEIKO SHO (KOBE STEEL, LTD.), Hyogo (JP)

(72) Inventors: Akira MATSUOKA, Kobe-shi, Hyogo (JP); Koji NOISHIKI, Takasago-shi, Hyogo (JP)

(73) Assignee: KABUSHIKI KAISHA KOBE SEIKO SHO (KOBE STEEL, LTD.), Hyogo (JP)

(21) Appl. No.: 17/640,865

(22) PCT Filed: Sep. 9, 2020
(86) PCT No.: PCT/JP2020/034193

§ 371 Date: Mar. 7, 2022

(30) Foreign Application Priority Data
Sep. 20, 2019 (JP) 2019-171359

(51) Int. Cl. B01D 11/02; B01J 19/24

(52) U.S. Cl. CPC B01D 11/0284; B01D 11/0207; B01J 19/245; B01D 2247/08; B01D 2257/60; B01J 2204/002

(57) ABSTRACT

The interaction system that causes an interaction between a first fluid and a second fluid includes a plurality of processing units configured so as to cause the second fluid separated in the separation container of each of the plurality of processing units to flow into the processing channel of the interaction unit of a processing unit that is next in flow order to the each of the plurality of processing units, the separation container of the each of the plurality of processing units is connected to the processing channel of the interaction unit of the processing unit that is next in the flow order, a first fluid feeding path that leads the first fluid separated in the separation container of a succeeding stage processing unit among the plurality of processing units from the separation container to the processing channel of the interaction unit of a preceding stage processing unit, a storage container that stores the first fluid led out from the separation container of the succeeding stage processing unit to the first fluid feeding path, and a delivery fluid supply unit that supplies a delivery fluid to the storage container so that the first fluid in the storage container is pushed out by the delivery fluid to flow through the first fluid feeding path into the processing channel of the preceding stage processing unit.

### TECHNICAL FIELD

the present invention relates to an interaction system that causes an interaction between a plurality of fluids.

### BACKGROUND ART

An interaction system that causes an interaction between a plurality of fluids has been known. This conventional interaction system includes interaction units of multiple stages that cause the fluids to make interactions with each other, respectively. Patent Literature 1 cited below discloses, as an example of such an interaction system, an extraction apparatus including extraction units of multiple stages each of which performs an extraction treatment of extracting a specific component from a raw material fluid and causing the specific component to move into an extractant.

Specifically, Patent Literature 1 cited below discloses an extraction apparatus including extraction units of multiple stages that are connected in series to cause the raw material fluid to flow in sequence, which extraction apparatus is configured to cause the extractant to flow in a direction opposite to a direction in which the raw material fluid flows through the extraction units of multiple stages in sequence.

In this extraction apparatus, each of the extraction units of multiple stages includes a channel structure having a plurality of channels therein. The plurality of channels are each configured to allow the extractant and the raw material fluid to flow therethrough in a state of being in contact with each other, and that, during the course of flowing, a specific component is extracted from the raw material fluid and moves into the extractant. To the outer surface of the channel structure, a discharge header is attached. An outlet of each of the plurality of channels communicates with an internal space of the discharge header. In this configuration, a mixture fluid of the extractant and the raw material fluid, the mixture fluid flowing through each channel, is discharged from the outlet of each channel into the internal space of the discharge header, and in this internal space, the mixture fluid separates into the extractant and the raw material fluid because of their difference in specific gravity.

A part of the discharge header of an extraction unit of each stage, the part holding the separated raw material fluid, is connected to the channel of an extraction unit of a next stage, via a pipe. As a result, the raw material fluid separated in the discharge header flows to the channel of the extraction unit of the next stage. A part of the discharge header of the extraction umit of each stage, the part holding the separated extractant, on the other hand, is connected to the channel of an extraction unit of a preceding stage, via a pipe. This pipe is provided with a pump that sends out the extractant separated in the discharge header to the preceding stage of the extraction unit. The extractant separated in the discharge header is thus sent out by this pump to flow into the channel of the extraction unit of the preceding stage.

An interaction system that causes, like the extraction apparatus disclosed in Patent Literature 1, the other fluid (extractant) to flow in a direction opposite to a direction in which one fluid (raw material fluid) flows through processing units (extraction units) of multiple stages in sequence generally adopts a configuration in which a pump is usually provided on a feeding path that leads the other fluid separated in a separation container of a processing unit of a succeeding stage, from the separation container to a channel of a processing unit of a preceding stage, and by this pump, the other fluid is sent to the channel of the processing unit of the preceding stage. In this manner, in the conventional interaction system, the other fluid separated in the separation container of the processing unit of the succeeding stage flows through the pump provided on the feeding path and is sent by the pump to the channel of the processing unit of the preceding stage.

However, the other fluid's flowing through the pump may cause the pump an inconvenient problem, depending on the properties of the other fluid. This has led to a demand that the number of pumps allowing the other fluid to flow therethrough be reduced.

### CITATION LIST

### Patent Literature

Patent Literature 1: Japanese Patent No. 5988504

### SUMMARY OF INVENTION

An object of the present invention is to provide an interaction system that can reduce the number of pumps through which a fluid separated in a separation container of a processing unit of a succeeding stage and sent to a processing channel of a processing unit of a preceding stage flows.

An interaction system provided as an aspect of the present invention is an interaction system that causes an interaction between a first fluid and a second fluid. The interaction system includes: a first fluid tank that stores the first fluid: a second fluid tank that stores the second fluid; a plurality of processing units each including an interaction unit and a separation container, the interaction unit having a processing channel therein, the processing channel allowing the first fluid and the second fluid to flow therethrough so as to cause the first fluid and the second fluid to come in contact with each other to make an interaction, the separation container receiving a mixture fluid of the first fluid and the second fluid discharged from the processing channel to retain the mixture fluid, to thereby cause the mixture fluid to separate into the first fluid and the second fluid, the plurality of processing units being configured such that the second fluid flows from the second fluid tank into the plurality of processing units in predetermined order, the separation container of the each of the plurality of processing units being connected to the processing channel of the interaction unit of the corresponding processing unit that is next in flow order so as to allow the second fluid separated in die separation container of each of the plurality of processing units to flow into the processing channel of the interaction unit of the processing unit that is next in flow order to the each of the plurality of processing units; a first fluid feeding path that leads the first fluid separated in the separation container of a succeeding stage processing unit from the separation container of the succeeding stage processing unit to the processing channel of the interaction unit of a preceding stage processing unit, the succeeding stage processing unit being the processing unit that succeeds a first stage processing unit that is the processing unit coming first in the flow order, the preceding stage processing unit being the processing unit that precedes the succeeding stage processing unit in the flow order; a storage container provided on the first fluid feeding path to store the first fluid led from the separation container of the succeeding stage processing unit to the first fluid feeding path; and a delivery fluid supply unit connected to the storage container and configured to supply a delivery fluid to the storage container so that the first fluid stored in the storage container is pushed out by the delivery fluid to flow through the first fluid feeding path into the processing channel of the interaction unit of the preceding stage processing unit

### BRIEF DESCRIPTION OF DRAWINGS

FIG. 1 is a schematic diagram of an interaction system according to a first embodiment of the present invention.

FIG. 2 is a control block diagram of the interaction system according to the first embodiment of the present invention.

FIG. 3 is a diagram for explaining an extraction method using the interaction system according to the first embodiment.

FIG. 4 is a diagram for explaining an extraction method using the interaction system according to the first embodiment.

FIG. 5 is a schematic diagram of an interaction system according to a second embodiment of the present invention.

FIG. 6 is a control block diagram of the interaction system according to the second embodiment of the present invention.

FIG. 7 is a diagram for explaining an extraction method using the interaction system according to the second embodiment.

FIG. 8 is a diagram for explaining an interaction method using the interaction system according to the second embodiment.

FIG. 9 is a schematic diagram of an interaction system according to a third embodiment of the present invention.

### DESCRIPTION OF EMBODIMENTS

Embodiments of the present invention will now be described with reference to the drawings.

### First Embodiment

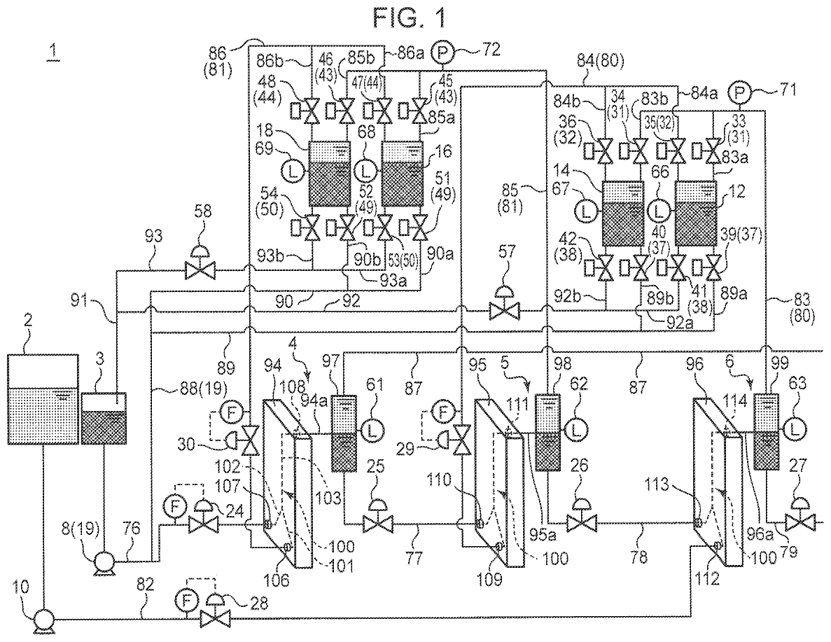

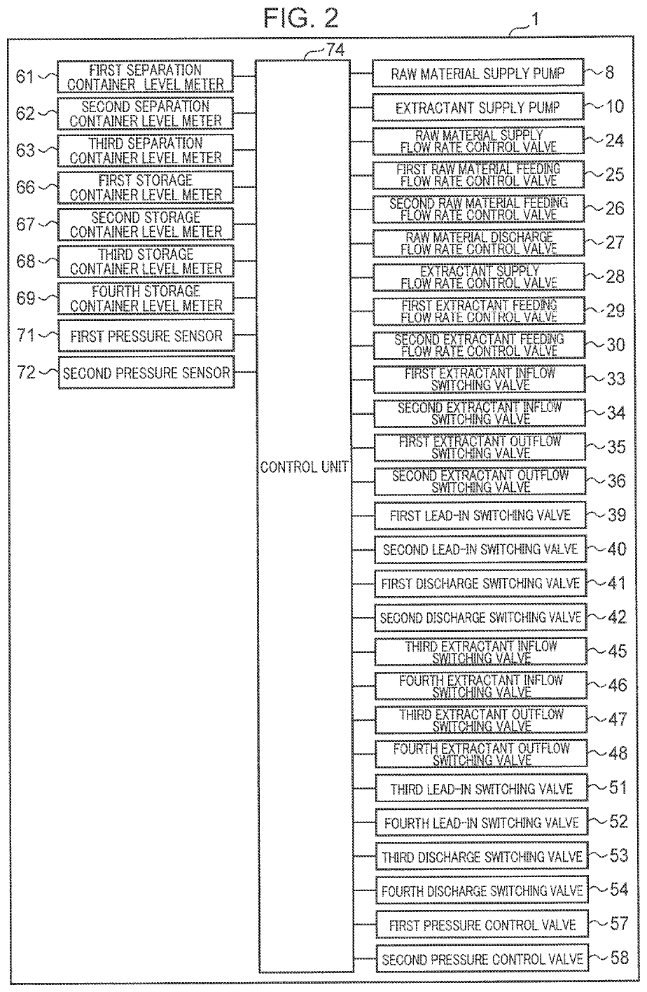

FIG. 1 depicts an overall configuration of an interaction system 1 according to a first embodiment of the present invention. FIG. 2 is a control block diagram of the interaction system 1 according to the first embodiment of the present invention. The interaction system 1 according to the first embodiment carries out, as an example of an interaction, an extraction treatment of extracting a specific component from a raw material liquid and causing the specific component to move into an extractant. The extractant is an example of a first fluid according to the present invention, and the raw material liquid is an example of a second fluid according to the present invention. The extractant is a liquid that is incompatible with the raw material liquid. The specific gravity of the extractant used in this first embodiment is smaller than the specific gravity of the raw material liquid.

The extraction treatment is executed in various forms, and various forms of the extraction treatments involve various combinations of the raw material liquid and the extractant. For example, one example of the extraction treatment is a treatment of extracting and separating a specific metal component from an aqueous solution containing a valuable metal dissolved therein. In such a treatment, the aqueous solution containing the valuable metal dissolved therein is the raw material liquid, and one example of such a solution is an aqueous solution containing a rare metal, such as Ni and Co, dissolved therein. As an extractant for extracting the rare metal, such as Ni and Co, from the aqueous solution, for example, a liquid created by diluting PC88A, a product from Daihachi Chemical Industry Co, Ltd., with kerosene is used. Another example of the extraction treatment is a treatment of extracting and removing a metal component from a liquid having undergone a polymer synthesis reaction, the metal component being dissolved in the liquid as a catalyst for synthesis. In this treatment, the liquid having undergone the polymer synthesis reaction is the raw material liquid, and, as the extractant for extracting the metal component, i.e., a specific component from the liquid, for example, water is used.

As shown in FIG. 1, the interaction system 1 according to the first embodiment includes an extractant tank 2, a raw material tank 3, a first processing unit 4, a second processing unit 5, a third processing unit 6, an extractant supply pump 10, a first storage container 12, a second storage container 14, a third storage container 16, a fourth storage container 18, and a delivery fluid supply unit 19.

The interaction system 1 also includes a raw material supply flow rate control valve 24, a first raw material feeding flow rate control valve 25, a second raw material feeding flow rate control valve 26, a raw material discharge flow rate control valve 27, an extractant supply flow rate control valve 28, a first extractant feeding flow rate control valve 29, a second extractant feeding flow rate control valve 30, a first pressure control valve 57, and a second pressure control valve 58.

The interaction system 1 further includes a first extractant filling switching device 31, a first extractant delivery switching device 32, a first delivery fluid lead-in switching device 37, a first delivery fluid discharge switching device 38, a second extractant filling switching device 43, a second extractant delivery switching device 44, a second delivery fluid lead-in switching device 49, and a second delivery fluid discharge switching device 50.

The interaction system 1 further includes a first separation container level meter 61, a second separation container level meter 62, a third separation container level meter 63, a first storage container level meter 66, a second storage container level meter 67, a third storage container level meter 68, a fourth storage container level meter 69, a first pressure sensor 71, a second pressure sensor 72, and a control unit 74.

Still, the interaction system 1 further includes a raw material supply pipe 76, a first feeding pipe 77, a second feeding pipe 78, a raw material discharge pipe 79, an extractant supply pipe 82, a first extractant feeding path 80, a second extractant feeding path 81, an extractant discharge pipe 87, and a delivery fluid recovery pipe 91.

The extractant tank 2 stores the extractant. Specifically, it stores the extractant not used in the extraction treatment yet. The extractant tank 2 is an example of a first fluid tank according to the present invention.

The raw material tank 3 stores the raw material liquid. Specifically, it stores the raw material liquid not subjected to the extraction treatment yet. The raw material tank 3 is an example of a second fluid tank according to the present invention.

The first processing unit 4, the second processing unit 5, and the third processing unit 6 each carry out the extraction treatment, using the extractant and the raw material liquid, and a separation treatment of separating a mixture fluid of the extractant and the raw material liquid having been subjected to the extraction treatment, into the extractant and the raw material liquid. The first to third processing units 4, 5, and 6 are examples of a plurality of processing units according to the present invention. The first processing unit 4, the second processing unit 5, and the third processing unit 6 are configured such that the raw material liquid from the raw material tank 3 sequentially flows therethrough in this order. The first processing unit 4 is an example of a first stage processing unit according to the present invention. The second processing unit 5 and the third processing unit 6 are examples of succeeding stage processing units according to the present invention. The first processing unit 4 is equivalent to a preceding stage processing unit preceding the second processing unit 5, and the second processing unit 5 is equivalent to a preceding stage processing unit preceding the third processing unit 6.

The first processing unit 4 includes a first interaction unit 94, a first separation container 97, and a first connection pipe 94a.

The first interaction unit 94 is a portion where the extraction treatment using the extractant and the raw material liquid is carried out. The first interaction unit 94 has a number of processing channels 100 therein. Each processing channel 100 allows the extractant and the raw material liquid to flow such that the extractant and the raw material liquid come into contact with each other to extract a specific component from the raw material liquid and cause the component to move into the extractant. It should be noted that in the figures, a number of processing channels 100 in the first interaction unit 94 are simplified in illustration into a single channel, and the shape of the processing channels 100 is also simplified in illustration as well. In addition, a number of processing channels 100 in a second interaction unit 95 and a number of processing channels 100 in a third interaction unit 96, both of which will be described later, are also simplified in illustration in the same manner. The number, arrangement, and respective shapes of the processing channels 100 in the interaction units 94, 95, and 96 are determined arbitrarily according to conditions for an interaction process (extraction treatment).

Each processing channel 100 is a so-called microchannel. Each processing channel 100 has a first lead-in channel 101, a second lead-in channel 102, and a processing channel portion 103. The first lead-in channel 101 is a portion into which the extractant is led. The second lead-in channel 102 is a portion into which the raw material liquid is led. The processing channel portion 103 is a Portion that is connected to downstream ends of the first and second lead-in channels 101 and 102 so that the extractant flows from the first lead-in channel 101 into the processing channel portion 103 as the raw material liquid flows from the second lead-in channel 102 into the same, and is a portion where the extractant flowing in from the first lead-in channel 101 and the raw material liquid flowing in from the second lead-in channel 102 join to flow in a state of being in contact with each other and the extraction treatment is carried out.

The first interaction unit 94 also has a first inlet 106, a second inlet 107., and an outlet 108.

The first inlet 106 is connected to the first lead-in channels 101 of all processing channels 100 of the first interaction unit 94. The first inlet 106 is a portion that receives the extractant. The extractant having passed through the first inlet 106 is delivered to each first lead-in channel 101 connected to the first inlet 106, and flows through the first lead-in channel 101.

The second inlet 107 is connected to the second lead-in channels 102 of all processing channels 100 of the first interaction unit 94. The second inlet 107 is a portion that receives the raw material liquid. The raw material liquid having passed through the second inlet 107 is delivered to each second lead-in channel 102 connected to the second inlet 107, and flows through the second lead-in channel 102.

The outlet 108 is connected to downstream ends of processing channel portions 103 of all processing channels 100 of the first interaction unit 94. The outlet 108 is a portion through which the extractant and the raw material liquid that have flown through the processing channel portion 103 of the first interaction unit 94, the extractant and raw material liquid having been subjected to the extraction treatment, flow out of the first interaction unit 94.

As will be described later, the first inlet 106 of the first interaction unit 94 is connected to an area of a second separation container 98 of the second processing unit 5, the area holding the separated extractant, via the second extractant feeding path 81. In this configuration, as will be described later, the extractant separated in the second separation container 98 of the second processing unit 5 of a succeeding stage is sent to the first inlet 106 of the first interaction unit 94.

The second inlet 107 of the first interaction unit 94 is connected to the raw material tank 3 via the raw material supply pipe 76. In other words, the processing channels 100 of the first interaction unit 94 is connected to the raw material tank 3 via the raw material supply pipe 76. The raw material supply pipe 76 connects the raw material tank 3 to the processing channel 100 of the first interaction unit 94 so as to lead the raw material liquid from the raw material tank 3 to the processing channel 100 of the first interaction unit 94 of the first processing unit 4, which is a first stage processing unit. The raw material supply pipe 76 is an example of a second fluid supply pipe according to the present invention.

As will be described later, the raw material supply pipe 76 is provided with a raw material supply pump 8 that is used also as a means for sending out the delivery fluid of the delivery fluid supply unit 19. The raw material supply pump 8 sends out the raw material liquid so that the raw material liquid flows from the raw material tank 3 to the processing channel 100 of the first interaction unit 94 of the first processing unit 4. The raw material supply pump 8 is an example of a second fluid delivery pump according to the present invention.

On a part of raw material supply pipe 76 that is further downstream (closer to the second inlet 107) than the raw material supply pump 8, the raw material supply flow rate control valve 24 is provided. The raw material supply flow rate control valve 24 controls the flow rate of the raw material liquid supplied to the second inlet 107 of the first interaction unit 94, that is, the flow rate of the raw material liquid sent to the second inlet 107 by the raw material supply pump 8.

The first separation container 97 is connected to the outlet 108 so as to receive a mixture fluid of the extractant and the raw material liquid flowing out of the processing channel portion 103 of each processing channel 100 of the first interaction unit 94, the extractant and raw material liquid having been subjected to the extraction treatment, that is, to receive the mixture fluid discharged from the outlet 108 of the first interaction unit 94. The first separation container 97 holds the received mixture fluid therein, thereby causing the mixture fluid to separate into the extractant and the raw material liquid due to their difference in specific gravity.

Specifically, the first separation container 97 is connected to the outlet 108 of the first interaction unit 94 via the first connection pipe 94a, and receives the mixture fluid discharged from the outlet 108 to flow through the first connection pipe 94a. In a space inside the first separation container 97, the mixture fluid vertically separates into a light liquid (extractant) and a heavy liquid (raw material liquid). The separated heavy liquid (raw material liquid) settles on the bottom of the first separation container 97, and the separated light liquid (extractant) settles on the heavy liquid settling on the bottom. An interface is formed between the heavy liquid and the light liquid retained in the first separation container 97.

The first separation container level meter 61 is attached to the first separation container 97. The first separation container level meter 61 detects the level position of the interface between the raw material liquid (heavy liquid) and the extractant (light liquid) retained in the first separation container 97. The first separation container level meter 61 transmits information on the detected level position of the interface to the control unit 74.

To an area of the first separation container 97, the area holding the separated extractant (light liquid), the extractant discharge pipe 87 is connected. Because of this configuration, the extractant separated in the first separation container 97 is discharged out of the interaction system 1 through the extractant discharge pipe 87.

The second processing unit 5 has the second interaction unit 95, the second separation container 98, and a second connection pipe 95a.

The second interaction unit 95, which is similar to the first interaction unit 94, has a number of processing channels 100 therein, which are similar to a number of processing channels 100 of the first interaction unit 94. The second interaction unit 95 has a first inlet 109, a second inlet 110, and an outlet 111 that are similar to the first inlet 106, the second inlet 107, and the outlet 108 of the first interaction unit 94.

The processing channel 100 of the second interaction unit 95 is connected to an area of the first separation container 97, the area holding the separated raw material liquid (heavy liquid), via the first feeding pipe 77 so that the raw material liquid separated in the first separation container 97 of the first processing unit 4 flows into the processing channel 100 of the second interaction unit 95 of the second processing unit 5, which is the processing unit next in flow order to the first processing unit 4. Specifically, the second inlet 110 of the second interaction unit 95 is connected to the area of the first separation container 97, the area holding the separated raw material liquid, via the first feeding pipe 77. As a result, the raw material liquid separated in the first separation container 97 is supplied from the first separation container 97 to the second inlet 110 through the first feeding pipe 77, and, from the second inlet 110, flows into the second lead-in channel 102 of each processing channel 100 of the second interaction unit 95.

The first feeding pipe 77 is provided with the first raw material feeding flow rate control valve 25. The first raw material feeding flow rate control valve 25 controls the flow rate of the raw material liquid flowing from the first separation container 97 to the processing channel 100 of the second interaction unit 95 through the first feeding pipe 77.

As will be described later, the first inlet 109 of the second interaction unit 95 is connected to an area of a third separation container 99 of the third processing unit 6, the area holding the separated extractant, via a first lead-in side pipe 83 and a first delivery side pipe 84 of the first extractant feeding path 80, the first storage container 12, and the second storage container 14. In this configuration, as will be described later, the extractant separated in the third separation container 99 of the third processing unit 6 of the succeeding stage is sent to the first inlet 109 of the second interaction unit 95.

The second separation container 98 is connected to the outlet 111 via the second connection pipe 95a so as to receive the mixture fluid of the extractant and the raw material liquid flowing out of each processing channel 100 of the second interaction unit 95, the extractant and raw material liquid having been subjected to the extraction treatment, that is, to receive the mixture fluid discharged from the outlet 111 of the second interaction unit 95. This second separation container 98, which is similar to the first separation container 97, holds the mixture fluid therein, the mixture fluid being received through the second connection pipe 95a, thereby causing the mixed fluid vertically separate into the extractant (light liquid) and the raw material liquid (heavy liquid) due to their difference in specific gravity.

The second separation container level meter 62 is attached to the second separation container 98. The second separation container level meter 62, which is similar to the first separation container level meter 61, detects the level position of an interface between the raw material liquid (heavy liquid) and the extractant (light liquid) retained in the second separation container 98. The second separation container level meter 62 transmits information on the detected level position of the interface to the control unit 74.

The third processing unit 6 has the third interaction unit 96, the third separation container 99, and a third connection pipe 96a.

The third interaction unit 96, which is similar to the first interaction unit 94, has a number of processing channels 100 therein, which are similar to a number of processing channels 100 of the first interaction unit 94. The third interaction unit 96 has a first inlet 112, a second inlet 113, and an outlet 114 that are similar to the first inlet 106, the second inlet 107, and the outlet 108 of the first interaction unit 94.

The processing channel 100 of the third interaction unit 96 is connected to an area of the second separation container 98, the area holding the separated raw material liquid (heavy liquid), via the second feeding pipe 78 so that the raw material liquid separated in the second separation container 98 of the second processing unit 5 flows into the processing channel 100 of the third interaction unit 96 of the third processing unit 6, which is the processing unit next in flow order to the second processing unit 5. Specifically, the second inlet 113 of the third interaction unit 96 is connected to the area of the second separation container 98, the area holding the separated raw material liquid, via the second feeding pipe 78, The separated raw material liquid is thus supplied from the second separation container 98 to the second inlet 113 through the second feeding pipe 78, and, from the second inlet 113, flows into the second lead-in channel 102 of each processing channel 100 of the third interaction unit 96.

The second feeding pipe 78 is provided with the second raw material feeding flow rate control valve 26. The second raw material feeding flow rate control valve 26 controls the flow rate of the raw material liquid flowing from the second separation container 98 to the processing channel 100 of the third interaction unit 96 through the second feeding pipe 78.

The first inlet 112 of the third interaction unit 96 is connected to the extractant tank 2 via the extractant supply pipe 82. In other words, the processing channel 100 of the third interaction unit 96 is connected to the extractant tank 2 via the extractant supply pipe 82. The extractant supply pipe 82 is provided with the extractant supply pump 10. The extractant supply pump 10 sends the extractant stored in the extractant tank 2 to the first inlet 112 of the third interaction unit 96 through the extractant supply pipe 82.

On a part of extractant supply pipe 82 that is further downstream (closer to the first inlet 112 of the third interaction unit 96) than the extractant supply pump 10, the extractant supply flow rate control valve 28 is provided. The extractant supply flow rate control valve 28 controls the flow rate of the extractant supplied to the first inlet 112 of the third interaction unit 96, that is, the flow rate of the extractant sent to the first inlet 112 by the extractant supply pump 10.

The third separation container 99 is connected to the outlet 114 via the third connection pipe 96a so as to receive the mixture fluid of the extractant and the raw material liquid flowing out of each processing channel 100 of the third interaction unit 96, the extractant and raw material liquid having been subjected to the extraction treatment, that is, to receive the mixture fluid discharged from the outlet 114 of the third interaction unit 96. This third separation container 99, which is similar to the first separation container 97, holds the mixture fluid therein, the mixture fluid being received through the third connection pipe 96a, thereby causing the mixed fluid vertically separate into the extractant (light liquid) and the raw material liquid (heavy liquid) due to their difference in specific gravity.

The third separation container level meter 63 is attached to the third separation container 99. The third separation container level meter 63, which is similar to the first separation container level meter 61, detects the level position of an interface between the raw material liquid (heavy liquid) and the extractant (light liquid) retained in the third separation container 99. The third separation container level meter 63 transmits information on the detected level position of the interface to the control unit 74.

To an area of the third separation container 99, the area holding the separated raw material liquid (heavy liquid), the raw material discharge pipe 79 is connected. The raw material discharge pipe 79 is provided with the raw material discharge flow rate control valve 27. The raw material discharge flow rate control valve 27 controls the flow rate of the raw material liquid discharged from the third separation container 99 to outside of the interaction system 1 through the raw material discharge pipe 79.

An area of the third separation container 99, the area holding the separated extractant (light liquid), is connected to the processing channel 100 of the second interaction unit 95 of the second processing unit 5 of the preceding stage, via the first extractant feeding path 80. This allows the extractant separated in the third separation container 99 to flow from the third separation container 99 to the processing channel 100 of the second interaction unit 95 through the first extractant feeding path 80. The first extractant feeding path 80 is an example of a first fluid feeding path according to the present invention.

The first extractant feeding path 80 has the first lead-in side pipe 83 and the first delivery side pipe 84. The first extractant feeding path 80 is provided with the first storage container 12 and with the second storage container 14. The first lead-in side pipe 83 connects the third separation container 99 to the first storage container 12 and to the second storage container 14 so as to lead the extractant flowing out of the third separation container 99, to the first storage container 12 and to the second storage container 14. The first delivery side pipe 84 connects the first storage container 12 and the second storage container 14 to the processing channel 100 (first inlet 109) of the second interaction unit 95 so as to lead the extractant stored in the first storage container 12 as well as the extractant stored in the second storage container 14 to the processing channel 100 of the second interaction unit 95.

Specifically, one end of the first lead-in side pipe 83 is connected to the area of the third separation container 99, the area holding the separated extractant (light liquid). A part of the first lead-in side pipe 83, the part being on the downstream side in the direction of flow of the extractant, branches into a first lead-in side connection pipe 83a connected to the first storage container 12 and into a second lead-in side connection pipe 83b connected to the second storage container 14. The first lead-in side connection pipe 83a is connected to the top of the first storage container 12. The second lead-in side connection pipe 83b is connected to the top of the second storage container 14.

One end of the first delivery side pipe 84 is connected to the first inlet 109 of the second interaction unit 95. A part of the first delivery side pipe 84, the part being on the upstream side in the direction of flow of the extractant, branches into a first delivery side connection pipe 84a connected to the first storage container 12 and into a second delivery side connection pipe 84b connected to the second storage container 14. The first delivery side connection pipe 84a is connected to the top of the first storage container 12. The second delivery side connection pipe 84b is connected to the top of the second storage container 14.

In the above configuration, the extractant separated in the third separation container 99 and led to the first lead-in side pipe 83 can flow through the first lead-in side connection pipe 83a of the first lead-in side pipe 83 and flow into an upper part of the inner space of the first storage container 12. The extractant, which has flown into the first storage container 12 and is held there, can flow out of the upper part of the inner space of the first storage container 12, flow through the first delivery side connection pipe 84a to reach the first delivery side pipe 84, and then flow through the first delivery side pipe 84 into the first inlet 109 of the second interaction unit 95. Likewise, the extractant separated in the third separation container 99 and led to the first lead-in side pipe 83 can flow through the second lead-in side connection pipe 83b of the first lead-in side pipe 83 and flow into an upper part of the inner space of the second storage container 14. The extractant, which has flown into the second storage container 14 and is held there, can flow out of the upper part of the inner space of the second storage container 14, flow through the second delivery side connection pipe 84b to reach the first delivery side pipe 84, and then flow through the first delivery side pipe 84 into the first inlet 109 of the second interaction unit 95.

The delivery fluid supply unit 19 is connected to the first storage container 12 and the second storage container 14. The delivery fluid supply unit 19 supplies a delivery fluid to the first storage container 12 and the second storage container 14 so that the extractants held respectively in the first storage container 12 and in the second storage container 14 are each pushed out by the delivery fluid and, as described above, flow through the first delivery side pipe 84 into the first inlet 1019 (processing channel 100) of the second interaction unit 95. As will be described later, the delivery fluid supply unit 19 supplies the delivery fluid to the third storage container 16 and the fourth storage container 18 so that the extractants held respectively in the third storage container 16 and in the fourth storage container 18 are each pushed out by the delivery fluid and flow through the second delivery side pipe 86 into the first inlet 106 (processing channel 100) of the first interaction unit 94.

In the first embodiment, the delivery fluid supply unit 19 is made up of the raw material supply pump 8, a part of the raw material supply pipe 76, and the delivery fluid supply pipe 88. The delivery fluid supply unit 19 supplies part of the raw material liquid supplied from the raw material tank 3 to the processing channel 100 of the first interaction unit 94, as the delivery fluid to the first storage container 12 and to the second storage container 14, and, as will be described later, supplies the same as the delivery fluid to the third storage container 16 and to the fourth storage container 18.

Specifically, the delivery fluid supply pipe 88 connects a part of raw material supply pipe 76 that is on the downstream side to the raw material supply pump 8 (on the side where the raw material supply pump 8 sends out the raw material liquid), to the first storage container 12 and to the second storage container 14 so as to lead part of the raw material liquid sent out by the raw material supply pump 8, to the first storage container 12 and to the second storage container 14, as the delivery fluid. More specifically, the delivery fluid supply pipe 88 is connected to the part of raw material supply pipe 76 that is on the downstream side to the raw material supply pump 8, and branches into a first delivery pipe 89 and a second delivery pipe 90 in the middle of extension of the delivery fluid supply pipe 88. The first delivery pipe 89 branches into a first delivery connection pipe 89a connected to the first storage container 12 and into a second delivery connection pipe 89b connected to the second storage container 14. The first delivery connection pipe 89a is connected to the bottom of the first storage container 12. The second delivery connection pipe 89b is connected to the bottom of the second storage container 14.

In the above configuration, part of the raw material liquid sent out by the raw material supply pump 8 can flow through the first delivery connection pipe 89a of the first delivery pipe 89 to reach the bottom of the first storage container 12, as a delivery fluid, and can also flow through the second delivery connection pipe 89b of the first delivery pipe 89 to reach the bottom of the second storage container 14, as a delivery fluid.

Because the raw material liquid is incompatible with the extractant and has a specific gravity larger than that of the extractant, the raw material liquid led into the first storage container 12 remains separated from the extractant and stays under the extractant in the first storage container 12. Similarly, the raw material liquid led into the second storage container 14 remains separated from the extractant and stays under the extractant in the second storage container 14. The extractant in the first storage container 12 is pushed upward by the raw material liquid led into the first storage container 12, is forced into the first delivery side connection pipe 84a, and, consequently, is sent to the first inlet 109 of the second interaction unit 95 through the first delivery side pipe 84. Similarly, the extractant in the second storage container 14 is pushed upward by the raw material liquid led into the second storage container 14, is forced into the second delivery side connection pipe 84b, and, consequently, is sent to the first inlet 109 of the second interaction unit 95 through the first delivery side pipe 84. In summary, the extractant, which is led into the first storage container 12 and the second storage container 14 and is held there, is eventually pushed out of the first storage container 12 and second storage container 14 by a raw material liquid delivery pressure applied by the raw material supply pump 8, and is sent to the first inlet 109 of the second interaction unit 95.

The first storage container 12 and the second storage container 14 are each connected to the raw material tank 3 via the delivery fluid recovery pipe 91. When the extractant is led into the first storage container 12 and the second storage container 14 to fill them, therefore, the raw material liquid as the delivery fluid discharged from the storage containers 12 and 14 can be sent to the raw material tank 3 through the delivery fluid recovery pipe 91, that is, can be recovered by the raw material tank 3.

Specifically, the delivery fluid recovery pipe 91 has its one end connected to the raw material tank 3, and branches into a first recovery pipe 92 and a second recovery pipe 93 in the middle of extension of the delivery fluid recovery pipe 91. The first recovery pipe 92 branches into a first recovery connection pipe 92a connected to the first storage container 12 and into a second recovery connection pipe 92b connected to the second storage container 14. The first recovery connection pipe 92a is connected to the bottom of the first storage container 12. The second recovery connection pipe 92b is connected to the bottom of the second storage container 14.

In this configuration, when the extractant is led into the first storage container 12 to fill it, the raw material liquid in the first storage container 12 is pushed downward by the extractant and discharged into the first recovery connection pipe 92a, and is sent to the raw material tank 3 through the first recovery pipe 92. Similarly, when the extractant is led into the second storage container 14 to fill it, the raw material liquid in the second storage container 14 is pushed downward by the extractant and discharged into the second recovery connection pipe 92b, and is sent to the raw material tank 3 through the first recovery pipe 92.

The first storage container level meter 66 is attached to the first storage container 12. The first storage container level meter 66 detects the level position of an interface formed between the extractant (light liquid) and the raw material liquid (heavy liquid) as the delivery fluid, both liquids being led into the first storage container 12, that is, detects the level position of a lower surface of the extractant held in the first storage container 12. The level position of the interface detected by the first storage container level meter 66 serves as an index value indicative of the amount of the extractant held in the first storage container 12. The level position of the interface detected by the first storage container level meter 66 is, therefore, an example of a first storage index value according to the present invention. The first storage container level meter 66 is an example of a first storage detection unit according to the present invention. The first storage container level meter 66 transmits information on the detected level position of the interface to the control unit 74.

The second storage container level meter 67 is attached to the second storage container 14. The second storage container level meter 67 detects the level position of an interface formed between the extractant (light liquid) and the raw material liquid (heavy liquid) as the delivery fluid, both liquids being led into the second storage container 14, that is, detects the level position of a lower surface of the extractant held in the second storage container 14. The level position of the interface detected by the second storage container level meter 67 serves as an index value indicative of the amount of the extractant held in the second storage container 14. The level position of the interface detected by the second storage container level meter 67 is, therefore, an example of a second storage index value according to the present invention. The second storage container level meter 67 is an example of a second storage detection unit according to the present invention. The second storage container level meter 67 transmits information on the detected level position of the interface to the control unit 74.

The first lead-in side pipe 83 of the first extractant feeding path 80 is provided with the first extractant filling switching device 31. The first extractant filling switching device 31 is a device that switches a container into which the extractant is led, the extractant flowing from the third separation container 99 into the first extractant feeding path 80, between the first storage container 12 and the second storage container 14. The first extractant filling switching device 31 is an example of a first fluid filling switching device according to the present invention.

The first extractant filling switching device 31 is configured to be capable of switching between a first filling permission state and a second filling permission state. The first filling permission state is a state of permitting the extractant to be led into the first storage container 12 to fill it and preventing the extractant from being led into the second storage container, the extractant being an extractant flowed from the third separation container 99 into the first lead-in side pipe 83 of the first extractant feeding path 80. The second filling permission state is a state of permitting the extractant to be led into the second storage container 14 to fill it and preventing the extractant from being led into the first storage container 12, the extractant being an extractant flowed from the third separation container 99 into the first lead-in side pipe 83. The first extractant filling switching device 31 includes a first extractant inflow switching valve 33 provided on the first lead-in side connection pipe 83a of the first lead-in side pipe 83, and a second extractant inflow switching valve 34 provided on the second lead-in side connection pipe 83b of the first lead-in side pipe 83.

The first extractant inflow switching valve 33 can be switched between an open state that permits the extractant flowing into the first storage container 12 through the first lead-in side connection pipe 83 and a closed state that prevents the extractant flowing into the first storage container 12. The second extractant inflow switching valve 34 can be switched between an open state that permits the extractant flowing into the second storage container 14 through the second lead-in side connection pipe 83b and a closed state that prevents the extractant flowing into the second storage container 14. A state of the first extractant inflow switching valve 33 being in the open state while the second extractant inflow switching valve 34 being in the closed state is equivalent to the first filling permission state of the first extractant filling switching device 31. A state of the first extractant inflow switching valve 33 being in the closed state while the second extractant inflow switching valve 34 being in the open state is equivalent to the second filling permission state of the first extractant filling switching device 31.

The first delivery side pipe 84 of the first extractant feeding path 80 is provided with the first extractant delivery switching device 32. The first extractant delivery switching device 32 is a device that switches a container from which the extractant is led out to be sent to the processing channel 100 of the second interaction unit 95, from one of the first storage container 12 and the second storage container 14 to the other of the same. The first extractant delivery switching device 32 is an example of a first fluid delivery switching device according to the present invention.

The first extractant delivery switching device 32 is configured to be capable of switching between a first delivery permission state and a second delivery permission state. The first delivery permission state is a state of permitting the extractant to be sent out from the first storage container 12 into the first delivery side pipe 84 and preventing the extractant from being sent out from, the second storage container 14 into the first delivery side pipe 84. The second delivery permission state is a state of permitting the extractant to be sent out from the second storage container 14 into the first delivery side pipe 84 and preventing the extractant from being sent out from the first storage container 12 into the first delivery side pipe 84. The first extractant delivery switching device 32 includes a first extractant outflow switching valve 35 provided on the first delivery side connection pipe 84a of the first delivery side pipe 84, and a second extractant outflow switching valve 36 provided on the second delivery side connection pipe 84b of the first delivery side pipe 84.

The first extractant outflow switching valve 35 can be switched between an open state that permits the extractant flowing from the first storage container 12 to the first delivery side pipe 84 through the first delivery side connection pipe 84a and a closed state that prevents the extractant flowing out of the first storage container 12. The second extractant outflow switching valve 36 can be switched between an open state that permits the extractant flowing from the second storage container 14 to the first delivery side pipe 84 through the second delivery side connection pipe 84b and a closed state that prevents the extractant flowing out of the second storage container 14. A state of the first extractant outflow switching valve 35 being in the open state while the second extractant outflow switching valve 36 being in the closed state is equivalent to the first delivery permission state of the first extractant delivery switching device 32. A state of the first extractant outflow switching valve 35 being in the closed state while the second extractant outflow switching valve 36 being in the open state is equivalent to the second delivery permission state of the first extractant delivery switching device 32.

On a part of the first delivery side pipe 84, the part being closer to the second interaction unit 95 than the part where the first delivery side pipe 84 branches into the first delivery side connection pipe 84a and the second delivery side connection pipe 84b, the first extractant feeding flow rate control valve 29 is provided. The first extractant feeding flow rate control valve 29 controls the flow rate of the extractant that is fed from the first storage container 12 or the second storage container 14 to the processing channel 100 of the second interaction unit 95 through the first delivery side pipe 84.

The first delivery pipe 89 of the delivery fluid supply pipe 88 is provided with the first delivery fluid lead-in switching device 37. The first delivery fluid lead-in switching device 37 is a device that switches a container into which the raw material liquid as the delivery fluid is led, between the first storage container 12 and the second storage container 14. The first delivery fluid lead-in switching device 37 is an example of a delivery fluid lead-in switching device according to the present invention.

The first delivery fluid lead-in switching device 37 is configured to be capable of switching between a first lead-in permission state and a second lead-in permission state. The first lead-in permission state is a state of permitting the raw material liquid as the delivery fluid to be led into the first storage container 12 through the first delivery pipe 89 and preventing the raw material liquid as the delivery fluid from being led into the second storage container 14 through the first delivery pipe 89. The second lead-in permission state is a state in which of permitting the raw material liquid as the delivery fluid to be led into the second storage container 14 through the first delivery pipe 89 and preventing the raw material liquid as the delivery fluid Tom being led into the first storage container 12 through the first delivery pipe 89. The first deliver; fluid lead-in switching device 37 has a first lead-in switching valve 39 provided on the first delivery connection pipe 89a of the first delivery pipe 89, and a second lead-in switching valve 40 provided on the second delivery connection pipe 89b of the first delivery pipe 89.

The first lead-in switching valve 39 can be switched between an open state that permits the raw material liquid's being led into the first storage container 12 through the first delivery connection pipe 89a and a closed state that prevents the raw material liquid's being led into the first storage container 12 through the first delivery connection pipe 89a. The second lead-in switching valve 40 can be switched between an open state that permits the raw material liquid's flowing into the second storage container 14 through the second delivery connection pipe 89b and a closed state that prevents the raw material liquid's flowing into the second storage container 14. A state of the first lead-in switching valve 39 being in the open state while the second lead-in switching valve 40 being in the closed state is equivalent to the first lead-in permission state of the first delivery fluid lead-in switching device 37. A state of the first lead-in switching valve 39 being in the closed state while the second lead-in switching valve 40 being in the open state is equivalent to the second lead-in permission state of the first delivery fluid lead-in switching device 37.

The first recovery pipe 92 of the delivery fluid recovery pipe 91 is provided with the first delivery fluid discharge switching device 38. The first delivery fluid discharge switching device 38 is a device that switches between a state in which the raw material liquid as the delivery fluid is discharged from the first storage container 12 to the first recovery pipe 92 and a state in which the raw material liquid as the delivery fluid is discharged from the second storage container 14 to the first recovery pipe 92. The first delivery fluid discharge switching device 38 is an example of a delivery fluid discharge switching device according to the present invention.

The first delivery fluid discharge switching device 38 is configured to be capable of switching between a first discharge permission state and a second discharge permission state. The first discharge permission state is a state of permitting the raw material liquid to be discharged from the first storage container 12 to the first recovery pipe 92 and preventing the raw material liquid from being discharged from the second storage container 14 to the first recovery pipe 92. The second discharge permission state is a state of permitting the raw material liquid to be discharged from the second storage container 14 to the first recovery pipe 92 and preventing the raw material liquid from being discharged from the first storage container 12 to the first recovery pipe 92. The first delivery fluid discharge switching device 38 includes a first discharge switching valve 41 provided on the first recovery connection pipe 92a of the first recovery pipe 92, and a second discharge switching valve 42 provided on the second recovery connection pipe 92b of the first recovery pipe 92.

The first discharge switching valve 41 can be switched between an open state that permits the raw material liquid's being discharged from the first storage container 12 to the first recovery pipe 92 through the first recovery connection pipe 92a and a closed state that prevents the raw material liquid's being discharged in this manner. The second discharge switching valve 42 can be switched between an open state that permits the raw material liquid's being discharged from the second storage container 14 to the first recovery pipe 92 through the second recovery connection pipe 92b and a closed state that prevents the raw material liquid's being discharged in this manner. A state of the first discharge switching valve 41 being in the open state while the second discharge switching valve 42 being in the closed state is equivalent to the first discharge permission state of the first delivery fluid discharge switching device 38. A state of the first discharge switching valve 41 being in the closed state while the second discharge switching valve 42 being in the open state is equivalent to the second discharge permission state of the first delivery fluid discharge switching device 38.

On a pail of the first lead-in side pipe 83, the part being closer to the third separation container 99 than the part where the first lead-in side pipe 83 branches into the first lead-in side connection pipe 83a and the second lead-in side connection pipe 83b, the first pressure sensor 71 is provided. The first pressure sensor 71 detects the pressure of the extractant in the first lead-in side pipe 83, that is, the pressure of the extractant supplied to the first storage container 12 or the second storage container 14 through the first lead-in side pipe 83. The first pressure sensor 71 transmits information on the detected pressure to the control unit 74.

On a part of the first recovery pipe 92, the part being closer to the raw material tank 3 than the part where the first recovery pipe 92 branches into the first recovery connection pipe 92a and the second recovery connection pipe 92b, the first pressure control valve 57 is provided. The first pressure control valve 57 is controlled by the control unit 74, based on a pressure detected by the first pressure sensor 71, thus controlling respective pressures of the raw material liquids discharged from the first storage container 12 and the second storage container 14 to the first recovery pipe 92, that is, adjusting the internal pressure of the first storage container 12 and that of the second storage container 14 to given pressures, respectively.

The area of the second separation container 98, the area holding the separated extractant (light liquid), is connected to the processing channel 100 of the first interaction unit 94 of the first processing unit 4 of the preceding stage, via the second extractant feeding path 81. This allows the extractant separated in the second separation container 98 to flow from the second separation container 98 to the processing channel 100 of the first interaction unit 94 through the second extractant feeding path 81. The second extractant feeding path 81 is an example of the first fluid feeding path according to the present invention.

The second extractant feeding path 81 includes a second lead-in side pipe 85 connected to the area of the second separation container 98, the area holding the separated extractant (light liquid), and a second delivery side pipe 86 connected to the first inlet 106 of the first interaction unit 94. The second extractant feeding path 81 is provided with the third storage container 16 and with the fourth storage container 18.

The second lead-in side pipe 85 is similar in configuration to the first lead-in side pipe 83, and branches into a third lead-in side connection pipe 85a connected to the third storage container 16 and into a fourth lead-in side connection pipe 85h connected to the fourth storage container 18. The second delivery side pipe 86 is similar in configuration to the first delivery side pipe 84, and branches into a third delivery side connection pipe 86a connected to the third storage container 16 and into a fourth delivery side connection pipe 86b connected to the fourth storage container 18.

The third storage container 16 is similar in function and configuration to the first storage container 12, and the fourth storage container 18 is similar in function and configuration to the second storage container 14. Specifically, each of the third storage container 16 and the fourth storage container 18 can temporarily store the extractant flowing therein and push out the stored extractant by the delivery fluid, which is supplied from the delivery fluid supply unit 19, to the second delivery side pipe 86, thereby sending the extractant to the first inlet 106 (processing channel 100) of the first interaction unit 94. The third storage container 16 and the fourth storage container 18 are examples of the first storage container and the second storage container according to the present invention, as the first storage container 12 and the second storage container 14 are.

Specifically, the third storage container 16 and the fourth storage container 18 are each connected to the part of raw material supply pipe 76 that is on the downstream side to the raw material supply pump 8 (side where the raw material supply pump 8 sends out the raw material liquid), via the delivery fluid supply pipe 88. In this configuration, part of the raw material liquid sent out by the raw material supply pump 8 can be supplied as the delivery fluid, to the third storage container 16 and to the fourth storage container 18 through the delivery fluid supply pipe 88.

The second delivery pipe 90 of the delivery fluid supply pipe 88 branches into a third delivery connection pipe 90a connected to the third storage container 16 and into a fourth delivery connection pipe 90b connected to the fourth storage container 18. The third delivery connection pipe 90a is connected to the bottom of the third storage container 16. The fourth delivery connection pipe 90b is connected to the bottom of the fourth storage container 18.

Similar to the case of the first delivery pipe 89, the second delivery pipe 90 can lead part of the raw material liquid sent out by the raw material supply pump 8, to the bottom of the third storage container 16 through the third delivery connection pipe 90a, as the delivery fluid and also to the bottom of the fourth storage container 18 through the fourth delivery connection pipe 90b, as the delivery fluid.

The third storage container 16 and the fourth storage container 1S are each connected to the raw material tank 3 via the delivery fluid recovery pipe 91. When the extractant is led into the third storage container 16 and the fourth storage container 18 to fill them, therefore, the raw material liquid as the delivery fluid discharged from the storage containers can be sent to the raw material tank 3 through the delivery fluid recovery pipe 91.

Specifically, the second recovery pipe 93 of the delivery fluid recovery pipe 91 branches into a third recovery connection pipe 93a connected to the third storage container 16 and into a fourth recovery connection pipe 93b connected to the fourth storage container 18. The third recovery connection pipe 93a is connected to the bottom of the third storage container 16. The fourth recovery connection pipe 93b is connected to the bottom of the fourth storage container 18.

Similar to the case of the first recovery pipe 92, the second recovery pipe 93 can lead the raw material liquid as the delivery fluid, the raw material liquid being discharged from the bottom of the third storage container 16 to the third recovery connection pipe 93a, to the raw material tank 3, and can also lead the raw material liquid as the delivery fluid, the raw material liquid being discharged from the bottom of the fourth storage container 18 to the fourth recovery connection pipe 93b, to the raw material tank 3.

The third storage container level meter 68 is attached to the third storage container 16. The third storage container level meter 68 detects the level position of an interface formed between the extractant (light liquid) and the raw material liquid (heavy liquid) as the delivery fluid, both liquids being led into the third storage container 16. The level position of the interface detected by the third storage container level meter 68 is an example of the first storage index value according to the present invention. The third storage container level meter 68 is an example of the first storage detection unit according to the present invention. The third storage container level meter 68 transmits information on the detected level position of the interface to the control unit 74.

The fourth storage container level meter 69 is attached to the fourth storage container 18. The fourth storage container level meter 69 detects the level position of an interface formed between the extractant (light liquid) and the raw material liquid (heavy liquid) as the delivery fluid, both liquids being led into the fourth storage container 18. The level position of the interface detected by the fourth storage container level meter 69 is an example of the second storage index value according to the present invention. The fourth storage container level meter 69 is an example of the second storage detection unit according to the present invention. The fourth storage container level meter 69 transmits information on the detected level position of the interface to the control unit 74.

The second lead-in side pipe 85 of the second extractant feeding path 81 is provided with the second extractant filling switching device 43. The second extractant filling switching device 43 is a device that switches a container into which the extractant is led, the extractant flowing from the second separation container 98 into the second extractant feeding path 81, between the third storage container 16 and the fourth storage container 18. The second extractant filling switching device 43 is an example of the first fluid filling switching device according to the present invention.

The second extractant filling switching device 43 is configured to be capable of switching between a third filling permission state and a fourth filling permission state. The third filling permission state is a state of permitting the extractant to be led into the third storage container 16 to fill it and preventing the extractant from being led into the fourth storage container 18, the extractant being an extractant flowed from the second separation container 98 into the second lead-in side pipe 85 of the second extractant feeding path 81. The fourth filling permission state is a state of permitting the extractant to be led into the fourth storage container 18 to fill it and preventing the extractant from being led into the third storage container 16, the extractant being an extractant flowed from the second separation container 98 into the second lead-in side pipe 85. The third filling permission state of the second extractant filling switching device 43 is equivalent to the first filling permission state according to the present invention, and the fourth filling permission state of the second extractant filling switching device 43 is equivalent to the second filling permission state according to the present invention.

The second extractant filling switching device 43 is similar in configuration to the first extractant filling switching device 31. Specifically, the second extractant filling switching device 43 includes a third extractant inflow switching valve 45 provided on the third lead-in side connection pipe 85a of the second lead-in side pipe 85, and a fourth extractant inflow switching valve 46 provided on the fourth lead-in side connection pipe 85b of the second lead-in side pipe 85. The third extractant inflow switching valve 45 and the fourth extractant inflow switching valve 46 are similar in function and configuration to the first extractant inflow switching valve 33 and the second extractant inflow switching valve 34, respectively.

The second delivery side pipe 86 of the second extractant feeding path 81 is provided with the second extractant delivery switching device 44. The second extractant delivery switching device 44 is a device that switches a container from which the extractant is led out to be sent to the processing channel 100 of the first interaction unit 94, from one of the third storage container 16 and the fourth storage container 18 to the other of the same. The second extractant delivery switching device 44 is an example of the first fluid delivery switching device according to the present invention.

The second extractant delivery switching device 44 is configured to be capable of switching between a third delivery permission state and a fourth delivery permission state. The third delivery permission state is a state of permitting the extractant to be sent out from the third storage container 16 into the second delivery side pipe 86 and preventing the extractant from being sent out from the fourth storage container 18 into the second delivery side pipe 86. The fourth delivery permission state is a state of permitting the extractant to be sent out from the fourth storage container 18 into the second delivery side pipe 86 and preventing the extractant from being sent out from the third storage container 16 into the second delivery side pipe 86. The third delivery permission state of the second extractant delivery switching device 44 is equivalent to the first delivery permission state according to the present invention, and the fourth delivery permission state of the second extractant delivery switching device 44 is equivalent to the second delivery permission state according to the present invention.

The second extractant delivery switching device 44 is similar in configuration to the first extractant delivery switching device 32. Specifically, the second extractant delivery switching device 44 includes a third extractant outflow switching valve 47 provided on the third delivery side connection pipe 86a of the second delivery side pipe 86, and a fourth extractant outflow switching valve 48 provided on the fourth delivery side connection pipe 86b of the second delivery side pipe 86. The third extractant outflow switching valve 47 and the fourth extractant outflow switching valve 48 are similar in function and configuration to the first extractant outflow switching valve 35 and the second extractant outflow switching valve 36, respectively.

On a part of the second delivery side pipe 6, the part being closer to the first interaction unit 94 than the part where the second delivery side pipe 86 branches into the third delivery side connection pipe 86a and the fourth delivery side connection pipe 86b, the second extractant feeding flow rate control valve 30 is provided. The second extractant feeding flow rate control valve 30 controls the flow rate of the extractant that is fed from the third storage container 16 or the fourth storage container 18 to the processing channel 100 of the first interaction unit 94 through the second delivery side pipe 86.

The second delivery pipe 90 of the delivery fluid supply pipe 88 is provided with the second delivery fluid lead-in switching device 49. The second delivery fluid lead-in switching device 49 is a device that switches a container into which the raw material liquid as the delivery fluid is led, between the third storage container 16 and the fourth storage container 18. The second delivery fluid lead-in switching device 49 is an example of the delivery fluid lead-in switching device according to the present invention.

The second delivery fluid lead-in switching device 49 is configured to be capable of switching between a third lead-in permission state and a fourth lead-in permission state. The third lead-in permission state is a state of permitting the raw material liquid as the delivery fluid to be led into the third storage container 16 through the second delivery pipe 90 and preventing the raw material liquid as the delivery fluid from being led into the fourth storage container 18 through the second delivery pipe 90. The fourth lead-in permission state is a state of permitting the raw material liquid as the delivery fluid to be led into the fourth storage container 18 through the second delivery pipe 90 and preventing the raw material liquid as the delivery fluid from being led into the third storage container 16 through the second delivery pipe 90. The third lead-in permission state of the second delivery fluid lead-in switching device 49 is equivalent to the first lead-in permission state according to the present invention, and the fourth lead-in permission state of the second delivery fluid lead-in switching device 49 is equivalent to the second lead-in permission state according to the present invention.

The second delivery fluid lead-in switching device 49 is similar in configuration to the first delivery fluid lead-in switching device 37. Specifically, the second delivery fluid lead-in switching device 49 includes a third lead-in switching valve 51 provided on the third delivery connection pipe 90a of the second delivery pipe 90, and a fourth lead-in switching valve 52 provided on the fourth delivery connection pipe 90b of the second delivery pipe 90. The third lead-in switching valve 51 and the fourth lead-in switching valve 52 are similar in function and configuration to the first lead-in switching valve 39 and the second lead-in switching valve 40, respectively.

The second recovery pipe 93 of the delivery fluid recovery pipe 91 is provided with the second delivery fluid discharge switching device 50. The second delivery fluid discharge switching device 50 is a device that switches between a state in which the raw material liquid as the delivery fluid is discharged from the third storage container 16 to the second recovery pipe 93 and a state in which the raw material liquid as the delivery fluid is discharged from the fourth storage container 18 to the second recovery pipe 93. The second delivery fluid discharge switching device 50 is an example of the delivery fluid discharge switching device according to the present invention.

The second delivery fluid discharge switching device 50 is configured to be capable of switching between a third discharge permission state and a fourth discharge permission state. The third discharge permission state is a state of permitting the raw material liquid to be discharged from the third storage container 16 to the second recovery pipe 93 and preventing the raw material liquid from being discharged from the fourth storage container 18 to the second recovery pipe 93. The fourth discharge permission state is a state of permitting the raw material liquid to be discharged from the fourth storage container 18 to the second recovery pipe 93 and preventing the raw material liquid from being discharged from the third storage container 16 to the second recovery pipe 93. The third discharge permission state of the second delivery fluid discharge switching device 50 is equivalent to the first discharge permission state according to the present invention, and the fourth discharge permission state of the second delivery fluid discharge switching device 50 is equivalent to the second discharge permission state according to the present invention.

The second delivery fluid discharge switching device 50 is similar in configuration to the first delivery fluid discharge switching device 38. Specifically, the second delivery fluid discharge switching device 50 includes a third discharge switching valve 53 provided on the third recovery connection pipe 93a of the second recovery pipe 93, and a fourth discharge switching valve 54 provided on the fourth recovery connection pipe 93b of the second recovery pipe 93. The third discharge switching valve 53 and the fourth discharge switching valve 54 are similar in function and configuration to the first discharge switching valve 41 and the second discharge switching valve 42, respectively.

On a part of the second lead-in side pipe 85, the part being closer to the second separation container 98 than the part where the second lead-in side pipe 85 branches into the third lead-in side connection pipe 85a and the fourth lead-in side connection pipe 85b, the second pressure sensor 72 is provided. The second pressure sensor 72 detects the pressure of the extractant in the second lead-in side pipe 85, that is, the pressure of the extractant supplied to the third storage container 16 or the fourth storage container 18 through the second lead-in side pipe 85. The second pressure sensor 72 transmits information on the detected pressure to the control unit 74.

On a part of the second recovery pipe 93, the part being closer to the raw material tank 3 than the part where the second recovery pipe 93 branches into the third recovery connection pipe 93a and the fourth recovery connection pipe 93b, the second pressure control valve 58 is provided. The second pressure control valve 58 is controlled by the control unit 74, based on a pressure detected by the second pressure sensor 72, thus controlling respective pressures of the raw material liquids discharged from the third storage container 16 and the fourth storage container 18 to the second recovery pipe 93, that is, adjusting the internal pressure of the third storage container 16 and that of the fourth storage container 18 to given pressures, respectively.

The control unit 74 acquires information on the level position of an interface between the raw material liquid and the extractant in the first separation container 97, the information being transmitted from the first separation container level meter 61, information on the level position of an interface between the raw material liquid and the extractant in the second separation container 98, the information being transmitted from the second separation container level meter 62, and information on the level position of an interface between the raw material liquid and the extractant in the third separation container 99, the information being transmitted from the third separation container level meter 63 The control unit 74 acquires also information on the level position of an interface between the raw material liquid and the extractant in the first storage container 12, the information being transmitted from the first storage container level meter 66, information on the level position of an interface between the raw material liquid and the extractant in the second storage container 14, the information being transmitted from the second storage container level meter 67, information on the level position of an interface between the raw material liquid and the extractant in the third storage container 16, the information being transmitted from the third storage container level meter 68, and information on the level position of an interface between the raw material liquid and the extractant in the fourth storage container 18, the information being transmitted from the fourth storage container level meter 69.

In addition, the control unit 74 controls respective operations of the raw material supply pump 8 and the extractant supply pump 10. Further, the control unit 74 controls a degree of opening of the raw material supply flow rate control valve 24 to control the flow rate of the raw material liquid supplied from the raw material tank 3 to the processing channel 100 of the first interaction unit 94.

Based on information on the level position of the interface, the information being received from the first separation container level meter 61, the control unit 74 controls a degree of opening of the first raw material feeding flow rate control valve 25 so as to keep the level position of the interface between the raw material liquid and the extractant in the first separation container 97 at a given level position, thereby controlling the flow rate of the raw material liquid flowing from the first separation container 97 to the processing channel 100 of the second interaction unit 95. Based on information on the level position of the interface, the information being received from the second separation container level meter 62, the control unit 74 controls a degree of opening of the second raw material feeding flow rate control valve 26 so as to keep the level position of the interface between the raw material liquid and the extractant in the second separation container 98 at a given level position, thereby controlling the flow rate of the raw material liquid flowing from the second separation container 98 to the processing channel 100 of the third interaction unit 96.

The control unit 74 controls a degree of opening of the raw material discharge flow rate control valve 27 to control the flow rate of the raw material liquid discharged from the third separation container 99 to outside of the interaction system 1.

The control unit 74 controls also a degree of opening of the extractant supply flow rate control valve 28 to control the flow rate of the extractant supplied from the extractant tank 2 to the processing channel 100 of the third interaction unit 96. The control unit 74 controls also a degree of opening of the first extractant feeding flow rate control valve 29 to control the flow rate of the extractant fed from one of the first storage container 12 and the second storage container 14 to the processing channel 100 of the second interaction unit 95. The control unit 74 controls also a degree of opening of the second extractant feeding flow rate control valve 30 to control the flow rate of the extractant fed from one of the third storage container 16 and the fourth storage container 18 to the processing channel 100 of the first interaction unit 94.

Further, the control unit 74 carries out control for causing the first extractant inflow switching valve 33 and the second extractant inflow switching valve 34 to switch between their open state and closed state, thereby causing the first extractant filling switching device 31 to switch between the first filling permission state and the second filling permission state. The control unit 74 also carries out control for causing the first extractant outflow switching valve 35 and the second extractant outflow switching valve 36 to switch between their open state and closed state, thereby causing the first extractant delivery switching device 32 to switch between the first delivery permission state and the second delivery permission state.

Further, the control unit 74 carries out control for causing the first lead-in switching valve 39 and the second lead-in switching valve 40 to switch between their open state and closed state, thereby causing the first delivers fluid lead-in switching device 37 to switch between the first lead-in permission state and the second lead-in permission state. The control unit 74 also carries out control for causing the first discharge switching valve 41 and the second discharge switching valve 42 to switch between their open state and closed state, thereby causing the first delivery fluid discharge switching device 38 to switch between the first discharge permission state and the second discharge permission state.

Further, the control unit 74 carries out control for causing the third extractant inflow switching valve 45 and the fourth extractant inflow switching valve 46 to switch between their open state and closed state, thereby causing the second extractant filling switching device 43 to switch between the third filling permission state and the fourth filling permission state. The control unit 74 also carries out control for causing the third extractant outflow switching valve 47 and the fourth extractant outflow switching valve 48 to switch between their open state and closed state, thereby causing the second extractant delivery switching device 44 to switch between the third delivery permission state and the fourth delivery permission state.

Further, the control unit 74 carries out control for causing the third lead-in switching valve 51 and the fourth lead-in switching valve 52 to switch between their open state and closed state, thereby causing the second delivery fluid lead-in switching device 49 to switch between the third lead-in permission state and the fourth lead-in permission state. The control unit 74 also carries out control for causing the third discharge switching valve 53 and the fourth discharge switching valve 54 to switch between their open state and closed state, thereby causing the second delivery fluid discharge switching device 50 to switch between the third discharge permission state and the fourth discharge permission state.

Specific details of control carried out by the control unit 74 will be given in the following description of an interaction method (extraction method).

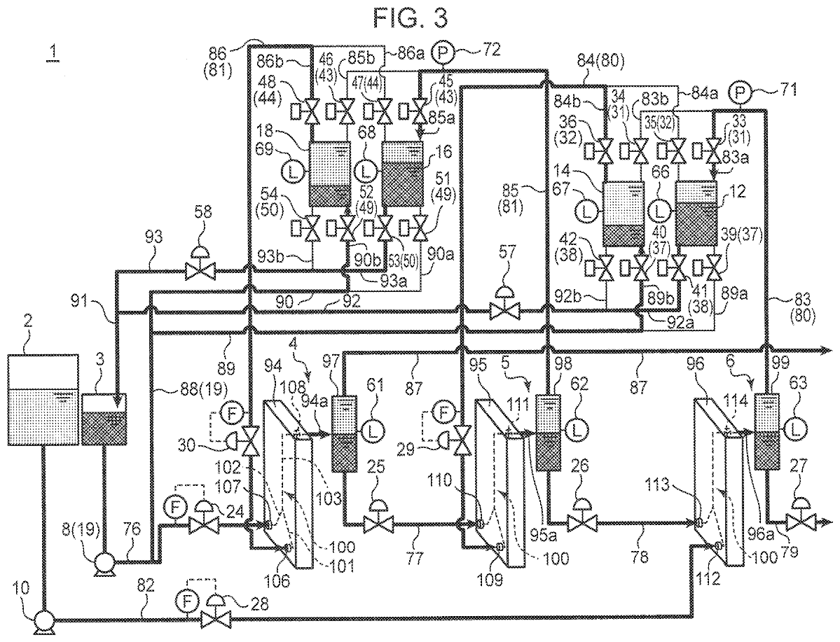

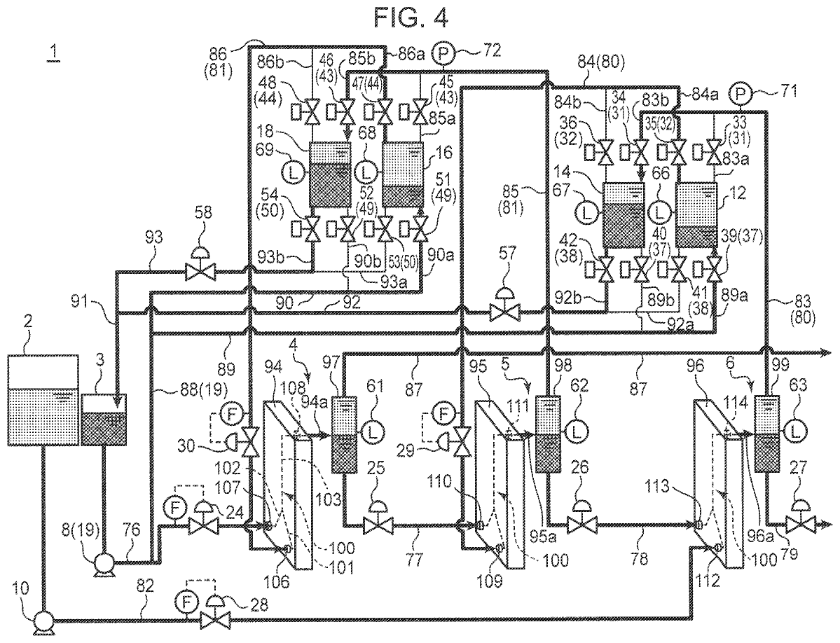

An interaction method using the interaction system 1 according to the first embodiment, specifically, an extraction method of extracting a specific component from the raw material liquid and causing the specific component to move into the extractant will then be described with reference to FIGS. 3 and 4. In FIGS. 3 and 4, flow paths through which the extractant and the raw material liquid flow are indicated by thick lines.

FIG. 3 depicts a state in which as a result of the first extractant filling switching device 31 being put into the first filling permission state, the first extractant delivery switching device 32 being put into the second delivery permission state, the first delivery fluid lead-in switching device 37 being put into the second lead-in permission state, and the first delivery fluid discharge switching device 38 being put into the first discharge permission state, the extractant led out of the third separation container 99 is fed into the first storage container 12 as the raw material liquid as the delivery fluid is discharged from the first storage container 12 into the raw material tank 3, that is, recovered by the raw material tank 3, and at the same time, the raw material liquid as the delivery fluid supplied from the delivery fluid supply unit 19 is led into the second storage container 14 as the extractant in the second storage container 14 is sent out to the processing channel 100 of the second interaction unit 95. FIG. 3 depicts also a state in which as a result of the second extractant filling switching device 43 being put into the third filling permission state, the second extractant delivery switching device 44 being put into the fourth delivery permission state, the second delivery fluid lead-in switching device 49 being put into the fourth lead-in permission state, and the second delivery fluid discharge switching device 50 being put into the third discharge permission state, the extractant led out of the second separation container 98 is fed into the third storage container 16 as the raw material liquid as the delivery fluid is discharged from the third storage container 16 into the raw material tank 3, that is, recovered by the raw material tank 3, and at the same time, the raw material liquid as the delivery fluid supplied from the delivery fluid supply unit 19 is led into the fourth storage container 18 as the extractant in the fourth storage container 18 is sent out to the processing channel 100 of the first interaction unit 94.

FIG. 4 depicts a state in which as a result of the first extractant filling switching device 31 being put into the second filling permission state, the first extractant delivery switching device 32 being put into the first delivery permission state, the first delivery fluid lead-in switching device 37 being put into the first lead-in permission state, and the first delivery fluid discharge switching device 38 being put into the second discharge permission state, the extractant led out of the third separation container 99 is fed into the second storage container 14 as the raw material liquid as the delivery fluid is discharged from the second storage container 14 into the raw material tank 3, that is, recovered by the raw material tank 3, and at the same time, the raw material liquid as the delivery fluid supplied from the delivery fluid supply unit 19 is led into the first storage container 12 as the extractant in the first storage container 12 is sent out to the processing channel. 100 of the second interaction unit 95. FIG. 4 depicts also a state in which as a result of the second extractant filling switching device 43 being put into the fourth filling permission state, the second extractant delivery switching device 44 being put into the third delivery permission state, the second delivery fluid lead-in switching device 49 being put into the third lead-in permission state, and the second delivery fluid discharge switching device 50 being put into the fourth discharge permission state, the extractant led out of the second separation container 98 is fed into the fourth storage container 18 as the raw material liquid as the delivery fluid is discharged from the fourth storage container 18 into the raw material tank 3, that is, recovered by the raw material tank 3, and at the same time, the raw material liquid as the delivery fluid supplied from the delivery fluid supply unit 19 is led into the third storage container 16 as the extractant in the third storage container 16 is sent out to the processing channel 100 of the first interaction unit 94.

In the interaction system 1 according to the first embodiment, the raw material liquid that is sent out from the raw material tank 3 by the raw material supply pump 8 sequentially flows through the processing channel 100 of the first interaction unit 94, the first separation container 97, the processing channel 100 of the second interaction unit 95, the second separation container 98, the processing channel 100 of the third interaction unit 96, and the third separation container 99 in this order.

Meanwhile, the extractant that is sent out from the extractant tank 2 by the extractant supply pump 10 flows into the processing channel 100 of the third interaction unit 96, comes in contact with the raw material liquid in the processing channel portion 103 of the processing channel 100, thus performing an extraction treatment of extracting a specific component from the raw material liquid. A mixture fluid of the extractant and the raw material liquid coming out of the processing channel 100 of the third interaction unit 96, the extractant and raw material liquid having been subjected to the extraction treatment, flows through the outlet 114 of the third interaction unit 96 and through the third connection pipe 96a, to flow into the third separation container 99. In the third separation container 99, the mixture fluid separates into the extractant (light liquid) and the raw material liquid (heavy liquid) due to their difference in specific gravity. The separated raw material liquid is discharged from the third separation container 99 to outside of the interaction system 1 through the raw material discharge pipe 79.

The extractant separated in the third separation container 99 is led out to the first lead-in side pipe 83, from which the extractant is led into the first storage container 12 to be stored therein when the state of FIG. 3 holds, and is led into the second storage container 14 to be stored therein when the state of FIG. 4 holds. Then, from a container into which the extractant is led, the container being one of the first storage container 12 and the second storage container 14, the raw material liquid as the delivery fluid is discharged to the first recovery pipe 92, from which the raw material liquid flows through the delivery fluid recovery pipe 91 into the raw material tank 3, that is, recovered by the raw material tank 3. Meanwhile, to a container to which inflow of the extractant is prevented, the container being one of the first storage container 12 and the second storage container 14, the raw material liquid as the delivery fluid supplied from the delivery fluid supply unit 19 flows in, and, consequently, the extractant stored in the container is pushed out by the incoming raw material liquid to be led out to the first delivery side pipe 84, and is sent to the processing channel 100 of the second interaction unit 95 through the first delivery side pipe 84.

In the processing channel 100 of the second interaction unit 95, the extractant sent to the processing channel 100 comes in contact with the raw material liquid and performs the extraction treatment in the same manner as in the case of the processing channel 100 of the third interaction unit 96. A mixture fluid of the extractant and the raw material liquid coming out of the processing channel 100 of the second interaction unit 95, the extractant and raw material liquid having been subjected to the extraction treatment, flows through the outlet 111 of the second interaction unit 95 and through the second connection pipe 95a, to flow into the second separation container 98. In the second separation container 98, the mixture fluid separates into the extractant (light liquid) and the raw material liquid (heavy liquid), as in the case of the third separation container 99. The separated raw material liquid is sent from the second separation container 98 to the processing channel 100 of the third interaction unit 96 through the second feeding pipe 78.

The extractant separated in the second separation container 98 is led out to the second lead-in side pipe 85, from which the extractant is led into the third storage container 16 to be stored therein when the state of FIG. 3 holds, and is led into the fourth storage container 18 to be stored therein when the state of FIG. 4 holds. Then, from a container into which the extractant is led, the container being one of the third storage container 16 and the fourth storage container 18, the raw material liquid as the delivery fluid is discharged to the second recovery pipe 93, from which the raw material liquid flows through the delivery fluid recovery pipe 91 into the raw material tank 3, that is, recovered by the raw material tank 3. Meanwhile, to a container to which inflow of the extractant is prevented, the container being one of the third storage container 16 and the fourth storage container 18, the raw material liquid as the delivery fluid supplied from the delivery fluid supply unit 19 flows in, and, consequently, the extractant stored in the container is pushed out by the incoming raw material liquid to be led out to the second delivery side pipe 86, and is sent to the processing channel 100 of the first interaction unit 94 through the second delivery side pipe 86.

In the processing channel 100 of the first interaction unit 94, the extractant sent to the processing channel 100 comes in contact with the raw material liquid and performs the extraction treatment in the same manner as in the case of the processing channel 100 of the third interaction unit 96. A mixture fluid of the extractant and the raw material liquid coming out of the processing channel 100 of the first interaction unit 94, the extractant and raw material liquid having been subjected to the extraction treatment, flows through the outlet 108 of the first interaction unit 94 and through the first connection pipe 94a, to flow into the first separation container 97. In the first separation container 97, the mixture fluid separates into the extractant (light liquid) and the raw material liquid (heavy liquid), as in the case of the third separation container 99. The separated raw material liquid is sent from the first separation container 97 to the processing channel 100 of the second interaction unit 95 through the first feeding pipe 77. The separated extractant, on the other hand, is discharged from the first separation container 97 to outside of the interaction system 1 through the extractant discharge pipe 87.

As indicated in FIG. 3, in a state in which the extractant led out of the third separation container 99 is fed into the first storage container 12 and the extractant stored in the second storage container 14 is sent to the processing channel 100 of the second interaction unit 95, when at least one of a first interface level lower limit condition and a second interface level upper limit condition is met, the control unit 74 puts the first extractant filling switching device 31 into the second filling permission state, puts the first extractant delivery switching device 32 into the first delivery permission state, puts the first delivery fluid lead-in switching device 37 into the first lead-in permission state, and puts the first delivery fluid discharge switching device 38 into the second discharge permission state, the first interface level lower limit condition being a condition that the level position of an interface between the extractant and the raw material liquid in the first storage container 12 reaches a lower limit level position set for the first storage container 12, the level position being detected by the first storage container level meter 66, the second interface level upper limit condition being a condition that the level position of an interface between the extractant and the raw material liquid in the second storage container 14 reaches an upper limit level position set for the second storage container 14, the level position being detected by the second storage container level meter 67. Specifically, the control unit 74 puts the second extractant inflow switching valve 34, the first extractant outflow switching valve 35, the first lead-in switching valve 39, and the second discharge switching valve 42 into the open state, respectively, while puts the first extractant inflow switching valve 33, the second extractant outflow switching valve 36, the second lead-in switching valve 40, and the first discharge switching valve 41 into the closed state, respectively. The lower limit level position set for the first storage container 12 is an index value corresponding to an upper limit to an extractant storage amount, the upper limit being set for the first storage container 12, and is an example of a first upper limit index value according to the present invention. The first interface level lower limit condition is an example of a first storage upper limit condition according to the present invention. The upper limit level position set for the second storage container 14 is an index value corresponding to a lower limit to the extractant storage amount, the lower limit being set for the second storage container 14, and is an example of a second lower limit index value according to the present invention. The second interface level upper limit condition is an example of a second storage lower limit condition according to the present invention.

In a state in which the extractant led out of the second separation container 98 is fed into the third storage container 16 and the extractant stored in the fourth storage container 18 is sent to the processing channel 100 of the first interaction unit 94, when at least one of a third interface level lower limit condition and a fourth interface level upper limit condition is met, the control unit 74 puts the second extractant filling switching device 43 into the fourth filling permission state, puts the second extractant delivery switching device 44 into the third delivery permission state, puts the second delivery fluid lead-in switching device 49 into the third lead-in permission state, and puts the second delivery fluid discharge switching device 50 into the fourth discharge permission state, the third interface level lower limit condition being a condition that the level position of an interface between the extractant and the raw material liquid in the third storage container 16 reaches a lower limit level position set for the third storage container 16, the level position being detected by the third storage container level meter 68, and the fourth interface level upper limit condition being a condition that the level position of an interface between the extractant and the raw material liquid in the fourth storage container 18 reaches an upper limit level position set for the fourth storage container 18, the level position being detected by the fourth storage container level meter 69. Specifically, the control unit 74 puts the fourth extractant inflow switching valve 46, the third extractant outflow switching valve 47, the third lead-in switching valve 51, and the fourth discharge switching valve 54 into the open state, respectively, while puts the third extractant inflow switching valve 45, the fourth extractant outflow switching valve 48, the fourth lead-in switching valve 52, and the third discharge switching valve 53 into the closed state, respectively. The lower limit level position set for the third storage container 16 is an index value corresponding to an upper limit to an extractant storage amount, the upper limit being set for the third storage container 16, and is an example of the first upper limit index value according to the present invention. The third interface level lower limit condition is an example of the first storage upper limit condition according to the present invention. The upper limit level position set for the fourth storage container 18 is an index value corresponding to a lower limit to the extractant storage amount, the lower limit being set for the fourth storage container 18, and is an example of the second lower limit index value according to the present invention. The fourth interface level upper limit condition is an example of the second storage lower limit condition according to the present invention.

The above-described switching control switches the state of the interaction system 1 to the state of FIG. 4. As a result, the extractant coming out of the third separation container 99 is led into the second storage container 14 to fill it, and the raw material liquid in the second storage container 14 is pushed out of the second storage container 14 by the extractant and flows through the delivery fluid recovery pipe 91 into the raw material tank 3 that is, recovered by the raw material tank 3. Meanwhile, part of the raw material liquid sent out by the raw material supply pump 8 flows through the first delivery connection pipe 89a of the first delivery pipe 89 of the delivery fluid supply pipe 88 and is led into the first storage container 12, as the delivery fluid. This raw material liquid pushes out the extractant in the first storage container 12 toward the first delivery side connection pipe 84a, thus sending the extractant to the processing channel 100 of the second interaction unit 95 through the first delivery side pipe 84.

As indicated in FIG. 4, in a state in which the extractant led out of the third separation container 99 is fed into the second storage container 14 and the extractant stored in the first storage container 12 is sent to the processing channel 100 of the second interaction unit 95, when at least one of a first interface level upper limit condition and a second interface level lower limit condition is met, the control unit 74 puts the first extractant filling switching device 31 into the first filling permission state, puts the first extractant delivery switching device 32 into the second delivery permission state, puts the first delivery fluid lead-in switching device 37 into the second lead-in permission state, and puts the first delivery fluid discharge switching device 38 into the second discharge permission state, the first interface level upper limit condition being a condition that the level position of an interface between the extractant and the raw material liquid in the first storage container 12 reaches an upper limit level position set for the first storage container 12, the level position being detected by the first storage container level meter 66, and the second interface level lower limit condition being a condition that the level position of an interface between the extractant and the raw material liquid in the second storage container 14 reaches a lower limit level position set for the second storage container 14, the level position being detected by the second storage container level meter 67. Specifically, the control unit 74 puts the first extractant inflow switching valve 33, the second extractant outflow switching valve 36, the second lead-in switching valve 40, and the first discharge switching valve 41 into the open state, respectively, while puts the second extractant inflow switching valve 34, the first extractant outflow switching valve 35, the first lead-in switching valve 39, and the second discharge switching valve 42 into the closed state, respectively. The upper limit level position set for the first storage container 12 is an index value corresponding to a lower limit to the extractant storage amount, the lower limit being set for the first storage container 12, and is an example of a first lower limit index value according to the present invention. The first interface level upper limit condition is an example of a first storage lower limit condition according to the present invention. The lower limit level position set for the second storage container 14 is an index value corresponding to an upper limit to the extractant storage amount, the upper limit being set for the second storage container 14, and is an example of a second upper limit index value according to the present invention. The second interface level lower limit condition is an example of a second storage upper limit condition according to the present invention.

In a state in which the extractant led out of the second separation container 98 is fed into the fourth storage container 18 and the extractant stored in the third storage container 16 is sent to the processing channel 100 of the first interaction unit 94, when at least one of a third interface level upper limit condition and a fourth interface level lower limit condition is met, the control unit 74 puts the second extractant filling switching device 43 into the third filling permission state, puts the second extractant delivery switching device 44 into the fourth delivery permission state, puts the second delivery fluid lead-in switching device 49 into the fourth lead-in permission state, and puts the second delivery fluid discharge switching device 50 into the third discharge permission state, the third interface level upper limit condition being a condition that the level position of an interface between the extractant and the raw material liquid in the third storage container 16 reaches an upper limit level position set for the third storage container 16, the level position being detected by the third storage container level meter 68, and the fourth interface level lower limit condition being a condition that the level position of an interface between the extractant and the raw material liquid in the fourth storage container 18 reaches a lower limit level position set for the fourth storage container 18, the level position being detected by the fourth storage container level meter 69. Specifically, the control unit 74 puts the third extractant inflow switching valve 45, the fourth extractant outflow switching valve 48, the fourth lead-in switching valve 52, and the third discharge switching valve 53 into the open state, respectively, while puts the fourth extractant inflow switching valve 46, the third extractant outflow switching valve 47, the third lead-in switching valve 51, and the fourth discharge switching valve 54 into the closed state, respectively. The upper limit level position set for the third storage container 16 is an index value corresponding to a lower limit to the extractant storage amount, the lower limit being set for the third storage container 16, and is an example of the first lower limit index value according to the present invention. The third interface level upper limit condition is an example of the first storage lower limit condition according to the present invention. The lower limit level position set for the fourth storage container 18 is an index value corresponding to an upper limit to the extractant storage amount, the upper limit being set for the fourth storage container 18, and is an example of the second upper limit index value according to the present invention. The fourth interface level lower limit condition is an example of the second storage upper limit condition according to the present invention.

The above-described switching control switches the state of the interaction system 1 to the state of FIG. 3. As a result, the extractant coming out of the third separation container 99 is led into the first storage container 12 to fill it, and the raw material liquid in the first storage container 12 is pushed out of the first storage container 12 by the extractant and flows through the delivery fluid recovery pipe 91 into the raw material tank 3, that is, recovered by the raw material tank 3. Meanwhile, part of the raw material liquid sent out by the raw material supply pump 8 flows through the second delivery connection pipe 89b of the first delivery pipe 89 of the delivery fluid supply pipe 88 and is led into the second storage container 14, as the delivery fluid. This raw material liquid pushes out the extractant in the second storage container 14 toward the second delivery side connection pipe 84b, thus sending the extractant to the processing channel 100 of the second interaction unit 95 through the first delivery side pipe 84.

In the above-described manner, the interaction system 1 of the first embodiment carries out the extraction treatment.

(Effects by First Embodiment)

In the interaction system 1 according to the first embodiment, the extractant separated in the third separation container 99 of the third processing unit 6 of the succeeding stage is temporarily stored in the first and second storage containers 12 and 14 provided on the first extractant feeding path 80, and the extractant stored in the first and second storage containers 12 and 14 is pushed out by the raw material liquid as the delivery fluid, which is supplied from the delivery fluid supply unit 19, and is sent to the processing channel 100 of the second interaction unit 95 of the second processing unit 5 of the preceding stage. In addition, the extractant separated in the second separation container 98 of the second processing unit 5 of the succeeding stage is temporarily stored in the third and fourth storage containers 16 and 18 provided on the second extractant feeding path 81, and the extractant stored in the third and fourth storage containers 16 and 18 is pushed out by the raw material liquid as the delivery fluid, which is supplied from the delivery fluid supply unit 19, and is sent to the processing channel 100 of the first interaction unit 94 of the first processing unit 4 of the preceding stage. In the interaction system 1 according to the first embodiment, therefore, the extractant sent from the third separation container 99 of the third processing unit 6 to the processing channel 100 of the second interaction unit 95 of the second processing unit 5 and the extractant sent from the second separation container 98 of the second processing unit 5 to the processing channel 100 of the first interaction unit 94 of the first processing unit 4 do not flow through pumps, whereas they flow through pumps in the conventional interaction system. The interaction system 1 of the first embodiment, therefore, can reduce the number of pumps through which the extractant separated by the third separation container 99 of the third processing unit 6 of the succeeding stage and sent to the processing channel 100 of the second processing unit 5 of the preceding stage flows and of pumps through which the extractant separated by the second separation container 98 of the second processing unit 5 of the succeeding stage and sent to the processing channel 100 of the first processing unit 4 of the preceding stage flows. This eliminates a concern that a case of the extractant causing a pump a problem, the pump allowing the extractant to flow therethrough, may occur, depending on the properties of the extractant.

In addition, in the interaction system 1 according to the first embodiment, part of the raw material liquid sent out by the raw material supply pump 8 is used as the delivery fluid, and a raw material liquid delivery pressure applied by the raw material supply pump 8 is used to push out the extractant stored in each of the first to fourth storage containers 12, 14, 16 and 18. This eliminates the need of separately providing a pump that creates a pressure for sending out the extractant stored in the first and second storage containers 12 and 14 to the processing channel 100 of the second interaction unit 95 and a pump that creates a pressure for sending out the extractant stored in the third and fourth storage containers 16 and 18 to the processing channel 100 of the first interaction unit 94. Hence the number of pumps included in the interaction system 1 can be reduced, and therefore costs required for pump maintenance can be reduced. [0139] in the interaction system 1 according to the first embodiment, the raw material liquid as the delivery fluid is supplied from the delivery fluid supply unit 19, which is a common delivery fluid supply unit, to each of the first to fourth storage containers 12, 14, 16 and 18, where the extractants stored in the first to fourth storage containers 12, 14, 16 and 18 are sent out, respectively. Therefore, even if the number of processing units included in the interaction system 1 increases and, consequently, the number of storage containers increases, an increase in the number of delivery fluid supply units 19 is prevented, and therefore the interaction system 1 becoming complicated in configuration can be prevented.

In the interaction system 1 according to the first embodiment, while the extractant is being sent from one storage container that is one of the first storage container 12 and the second storage container 14 to the processing channel 100 of the second interaction unit 95, the extractant led out of the third separation container 99 is fed into the other storage container that is the other of the first storage container 12 and the second storage container 14. Then, at a point of time at which the storage amount of the extractant in the one storage container, which is sending the extractant to the processing channel 100 of the second interaction unit 95, reduces to the lower limit or the storage amount of the extractant in the other storage container, into which the extractant is fed, reaches the upper limit, the extractant is sent out from the other storage container to the processing channel 100 of the second interaction unit 95 as the extractant is led into the one storage container to fill. In this manner, a storage container into which the extractant led out of the third separation container 99 is fed and a storage container that sends out the extractant to the processing channel 100 of the second interaction unit 95 can be switched to each other, After the storage amount of the extractant in a container that is one of the first storage container 12 and the second storage container 14 reduces, therefore, the extraction treatment in the processing channel 100 of the second interaction unit 95 can be carried out continuously without waiting the container being refilled with the extractant.

Likewise, while the extractant is being sent from one storage container that is one of the third storage container 16 and the fourth storage container 18 to the processing channel 100 of the first interaction unit 94, the extractant led out of the second separation container 98 is fed into the other storage container that is the other of the third storage container 16 and the fourth storage container 18. Then, at a point of time at which the storage amount of the extractant in the one storage container, which is sending the extractant to the processing channel 100 of the first interaction unit 94, reduces to the lower limit or the storage amount of the extractant in the other storage container, into which the extractant is fed, reaches the upper limit, the extractant is sent out from the other storage container to the processing channel 100 of the first interaction unit 94 as the extractant is led into the other storage container to fill it. In this manner, a storage container into which the extractant led out of the second separation container 98 is fed and a storage container that sends out the extractant to the processing channel 100 of the first interaction unit 94 can be switched to each other. After the storage amount of the extractant in a container that is one of the third storage container 16 and the fourth storage container 18 reduces, therefore, the extraction treatment in the processing channel 100 of the second interaction unit 95 can be carried out continuously without waiting the container being refilled with the extractant.

In the interaction system 1 according to the first embodiment, the control unit 74 carries out control for switching respective states of the first extractant filling switching device 31, the first extractant delivery switching device 32, the first delivery fluid lead-in switching device 37, and the first delivery fluid discharge switching device 38, thereby allowing automatic switching between the state in which the extractant led out of the third separation container 99 is fed into the first storage container 12 and the extractant is sent from the second storage container 14 to the processing channel 100 of the second interaction unit 95 and the state in which the extractant led out of the third separation container 99 is fed into the second storage container 14 and the extractant is sent from the first storage container 12 to the processing channel 100 of the second interaction unit 95. The control unit 74 also carries out control for switching respective states of the second extractant filling switching device 43, the second extractant delivery switching device 44, the second delivery fluid lead-in switching device 49, and the second delivery fluid discharge switching device 50, thereby allowing automatic switching between the state in which the extractant led out of the second separation container 98 is fed into the third storage container 16 and the extractant is sent from the fourth storage container 18 to the processing channel 100 of the first interaction unit 94 and the state in which the extractant led out of the second separation container 98 is fed into the fourth storage container 18 and the extractant is sent from the third storage container 16 to the processing channel 100 of the first interaction unit 94.

### Second Embodiment

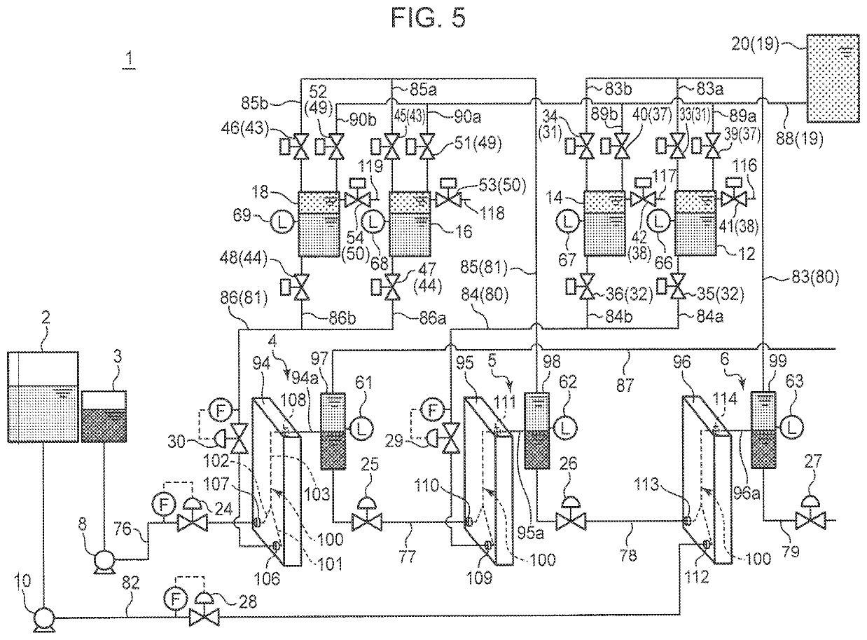

An interaction system 1 according to a second embodiment of the present invention will hereinafter be described with reference to FIGS. 5 to 8.

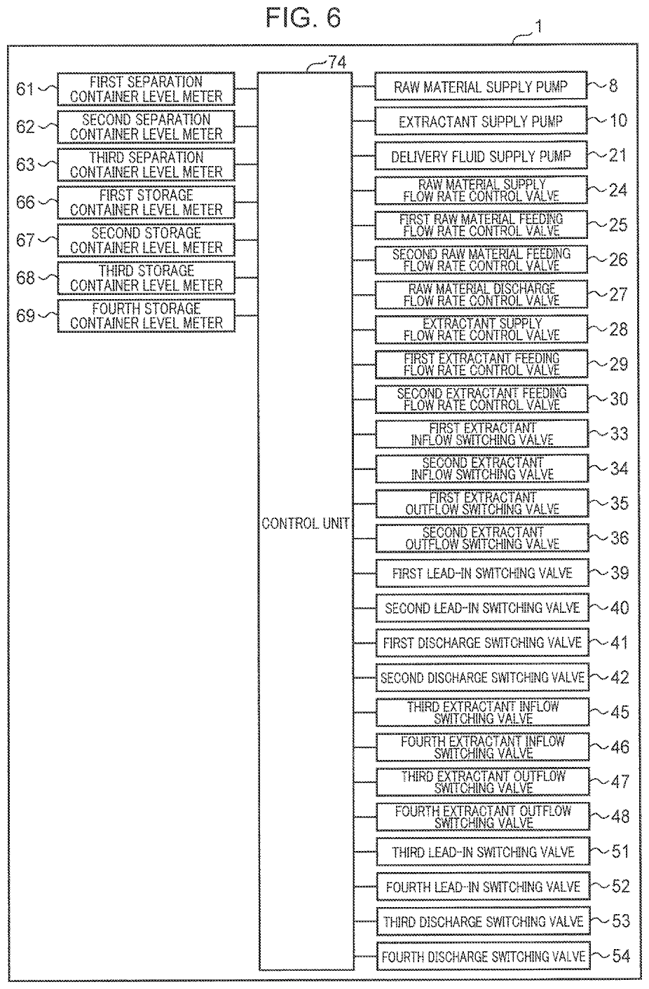

FIG. 5 depicts an overall configuration of the interaction system 1 according to the second embodiment. FIG. 6 is a control block diagram of the interaction system 1 according to the second embodiment.

Different from the interaction system 1 according to the first embodiment, the interaction system 1 according to the second embodiment is configured such that the extractant stored in the first to fourth storage containers 12, 14, 16, and 18 is pushed out of them by a delivery fluid different from the raw material liquid and extractant and is sent to the corresponding processing channels 100 of the first and second interaction units 94 and 95.

Specifically, in the interaction system 1 according to the second embodiment, the delivery fluid supply unit 19, which supplies the delivery fluid to each of the first to fourth storage containers 12, 14, 16, and 18, has a delivery fluid tank 20 and the delivery fluid supply pipe 88.

The delivery fluid tank 20 is a supply source for the delivery fluid for pushing the extractant stored in the first to fourth storage containers 12, 14, 16, 18 out of them, and stores the delivery fluid with a pressure higher than the internal pressures of the first to fourth storage containers 12, 14, 16 and 18. The delivery fluid according to the second embodiment is a fluid incompatible with the extractant, and is provided as a liquid or a gas. A proper fluid is adopted as the delivery fluid in accordance with the type of the extractant, and in the second embodiment, a fluid with a specific gravity smaller than that of the extractant is used.

The delivery fluid supply pipe 88 connects the delivery fluid tank 20 to each of the first to fourth storage containers 12, 14, 16, and 18 so as to lead the delivery fluid held in the delivery fluid tank 20 from the delivery fluid tank 20 to each of the first to fourth storage containers 12, 14, 16 and 18. The delivery fluid supply pipe 88 has the first delivery connection pipe 89a, the second delivery connection pipe 89b, the third delivery connection pipe 90a, and the fourth delivery connection pipe 90b, which branch respectively out of the delivery fluid supply pipe 88. The first to fourth delivery connection pipes 89a, 89b, 90a, and 90b are connected respectively to the tops of the first to fourth storage containers 12, 14, 16, and 18. In this configuration, the delivery fluid supplied from the delivery fluid tank 20 flows through the first to fourth delivery connection pipes 89a, 89b, 90a, and 90b to reach respective tops of inner spaces of the first to fourth storage containers 12, 14, 16, and 18.

In the second embodiment, the first delivery side connection pipe 84a of the first delivery side pipe 84 of the first extractant feeding path 80 is connected to the bottom of the first storage container 12, and the second delivery side connection pipe 84b of the first delivery side pipe 84 of the first extractant feeding path 80 is connected to the bottom of the second storage container 14. In addition, the third delivery side connection pipe 86a of the second delivery side pipe 86 of the second extractant feeding path 81 is connected to the bottom of the third storage container 16, and the fourth delivery side connection pipe 86b of the second delivery side pipe 86 of the second extractant feeding path 81 is connected to the bottom of the fourth storage container 18. Because the specific gravity of the extractant is larger than that of the delivery fluid, the extractant led to the inner spaces of the first to fourth storage containers 12, 14, 16 and 18 settles under the delivery fluid led to the inner spaces of these storage containers, and is led out of the bottoms of the inner spaces of these storage containers into the first to fourth delivery side connection pipes 84a, 84b, 86a, and 86b.

A first delivery fluid discharge pipe 116 is connected to an upper part of the first storage container 12. When the extractant is fed into the first storage container 12, the extractant pushes out the delivery fluid in the first storage container 12 toward the first delivery fluid discharge pipe 116, thus pushing the delivery fluid out of the first storage container 12.

The first delivery fluid discharge pipe 116 is provided with the first discharge switching valve 41. The first discharge switching valve 41 can be switched between an open state that permits discharging the fluid from the first storage container 12 through the first delivery fluid discharge pipe 116 and a closed state that prevents discharging the fluid in such a manner.

A second delivery fluid discharge pipe 117 is connected to an upper part of the second storage container 14. When the extractant is fed into the second storage container 14, the extractant pushes out the delivery fluid in the second storage container 14 toward the second delivery fluid discharge pipe 117, thus pushing the delivery fluid out of the second storage container 14.

The second delivery fluid discharge pipe 117 is provided with the second discharge switching valve 42. The second discharge switching valve 42 can be switched between an open state that permits discharging the fluid from the second storage container 14 through the second delivery fluid discharge pipe 117 and a closed state that prevents discharging the fluid in such a manner.

A third delivery fluid discharge pipe 118 is connected to an upper part of the third storage container 16. When the extractant is fed into the third storage container 16, the extractant pushes out the delivery fluid in the third storage container 1 toward the third delivery fluid discharge pipe 118, thus pushing the delivery fluid out of the third storage container 16.

The third delivery fluid discharge pipe 118 is provided with the third discharge switching valve 53. The third discharge switching valve 53 can be switched between an open state that permits discharging the fluid from the third storage container 16 through the third delivery fluid discharge pipe 118 and a closed state that prevents discharging the fluid in such a manner.

A fourth delivery fluid discharge pipe 119 is connected to an upper part of the fourth storage container 18. When the extractant is fed into the fourth storage container 18, the extractant pushes out the delivery fluid in the fourth storage container 18 toward the fourth delivery fluid discharge pipe 119, thus pushing the delivery fluid out of the fourth storage container 18.

The fourth delivery fluid discharge pipe 119 is provided with the fourth discharge switching valve 54. The fourth discharge switching valve 54 can be switched between an open state that permits discharging the fluid from the fourth storage container 18 through the fourth delivery fluid discharge pipe 119 and a closed state that prevents discharging the fluid in such a manner.

Except the above-described constituent elements, the configuration of the interaction system 1 according to the second embodiment is the same as the configuration of the interaction system 1 according to the first embodiment.

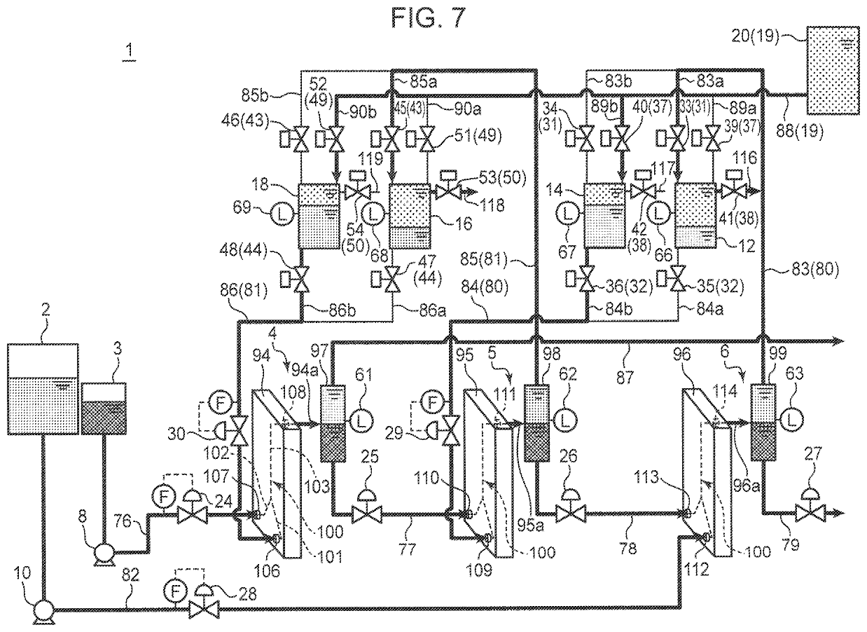

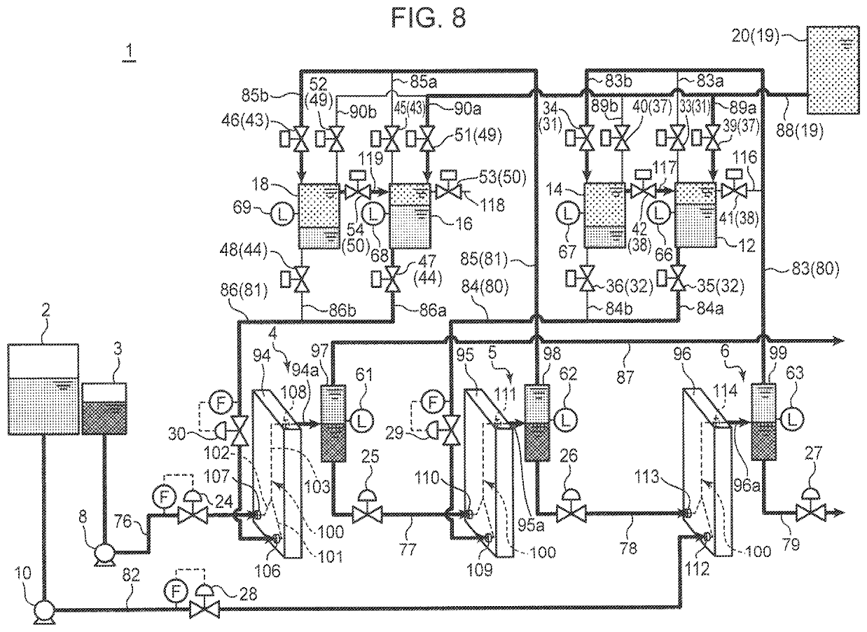

An extraction method using the interaction system 1 according to the second embodiment will then be described with reference to FIGS. 7 and 8. In FIGS. 7 and 8, the flow paths through which the extractant and the raw material liquid flow are indicated by thick lines.

FIG. 7 depicts a state in which as a result of the first extractant filling switching device 31 being put into the first filling permission state, the first extractant delivery switching device 32 being put into the second delivery permission state, the first delivery fluid lead-in switching device 37 being put into the second lead-in permission state, and the first delivery fluid discharge switching device 38 being put into the first discharge permission state, the extractant led out of the third separation container 99 is fed into the first storage container 12 as the delivery fluid is discharged from the first storage container 12, and at the same time, the delivery fluid supplied from the delivery fluid tank 20 is led into the second storage container 14 as the extractant in the second storage container 14 is sent out to the processing channel 100 of the second interaction unit 95. FIG. 7 depicts also a state in which as a result of the second extractant filling switching device 43 being put into the third filling permission state, the second extractant delivery switching device 44 being put into the fourth delivery permission state, the second delivery fluid lead-in switching device 49 being put into the fourth lead-in permission state, and the second delivery fluid discharge switching device 50 being put into the third discharge permission state, the extractant led out of the second separation container 98 is fed into the third storage container 16 as the delivery fluid is discharged from the third storage container 16, and at the same time, the delivery fluid supplied from the delivery fluid tank 20 is led into the fourth storage container 18 as the extractant in the fourth storage container 18 is sent out to the processing channel 100 of the first interaction unit 94.

FIG. 8 depicts a state in which as a result of the first extractant filling switching device 31 being put into the second filling permission state, the first extractant delivery switching device 32 being put into the first delivery permission state, the first delivery fluid lead-in switching device 37 being put into the first lead-in permission state, and the first delivery fluid discharge switching device 38 being put into the second discharge permission state, the extractant led out of the third separation container 99 is fed into the second storage container 14 as the delivery fluid is discharged from the second storage container 14, and at the same time, the delivery fluid supplied from the delivery fluid tank 20 is led into the first storage container 12 as the extractant in the first storage container 12 is sent out to the processing channel 100 of the second interaction unit 95. FIG. 8 depicts also a state in which as a result of the second extractant filling switching device 43 being put into the fourth filling permission state, the second extractant delivery switching device 44 being put into the third delivery permission state, the second delivery fluid lead-in switching device 49 being put into the third lead-in permission state, and the second delivery fluid discharge switching device 50 being put into the fourth discharge permission state, the extractant led out of the second separation container 98 is fed into the fourth storage container 18 as the delivery fluid is discharged from the fourth storage container 18, and at the same time, the delivery fluid supplied from the delivery fluid tank 20 is led into the third storage container 16 as the extractant in the third storage container 16 is sent out to the processing channel 100 of the first interaction unit 94.

By the extraction method according to the second embodiment, the same processes by the extraction method according to the first embodiment are carried out, except a process of pushing the extractant stored in the first to fourth storage containers 12, 14, 16 and 18 out of them by the delivery fluid, which is supplied from the delivery fluid tank 20 through the delivery fluid supply pipe 88, and sending the extractant to the corresponding processing channels 100 of the first interaction unit 94 and the second interaction unit 95.

In the second embodiment, because the specific gravity of the extractant is larger than the specific gravity of the delivery fluid, when the extractant is fed into the first to fourth storage containers 12, 14, 16, and 18, the extractant, which is led into the first to fourth storage container 12, 14, 16, and 18 from their tops, passes through the delivery fluid in these storage containers to settle on their bottoms. As the amount of the extractant led into the containers increases, therefore, the level position of an interface between the extractant and the delivery fluid lying directly above the extractant rises. As a result, the delivery fluid is pushed out of each of the first to fourth storage containers 12, 14, 16 and 18, and is discharged through the first to fourth delivery fluid discharge pipes 116, 117, 118, and 119 corresponding respectively to the first to fourth storage containers 12, 14, 16 and 18.

In the second embodiment, when at least one of the first interface level upper limit condition and the second interface level lower limit condition is met, the control unit 74 switches the filling permission state of the first extractant filling switching device 31 from the first filling permission state to the second filling permission state, switches the delivery permission state of the first extractant delivery switching device 32 from the second delivery permission state to the first delivery permission state, switches the lead-in permission state of the first delivery fluid lead-in switching device 37 from the second lead-in permission state to the first lead-in permission state, and switches the discharge permission state of the first delivery fluid discharge switching device 38 from the first discharge permission state to the second discharge permission state, the first interface level upper limit condition being a condition that the level position of the interface detected by the first storage container level meter 66 reaches the upper limit level position set for the first storage container 12, and the second interface level lower limit condition being a condition that the level position of the interface detected by the second storage container level meter 67 reaches the lower limit level position set for the second storage container 14. On the other hand, when at least one of the first interface level lower limit condition and the second interface level upper limit condition is met, the control unit 74 switches the filling permission state of the first extractant filling switching device 31 from the second filling permission state to the first filling permission state, switches the delivery permission state of the first extractant delivery switching device 32 from the first delivery permission state to the second delivery permission state, switches the lead-in permission state of the first delivery fluid lead-in switching device 37 from the first lead-in permission state to the second lead-in permission state, and switches the discharge permission state of the first delivery fluid discharge switching device 38 from the second discharge permission state to the first discharge permission state, the first interface level lower limit condition being a condition that the level position of the interface detected by the first storage container level meter 66 reaches the lower limit level position set for the first storage container 12, and the second interface level tipper limit condition being a condition that the level of the interface detected by the second storage container level meter 67 reaches the upper limit level position set for the second storage container 14.

In the second embodiment, the upper limit level position set for the first storage container 12 is an example of the first upper limit index value of the present invention, the lower limit level position set for the first storage container 12 is an example of the first lower limit index value of the present invention, the upper limit level position set for the second storage container 14 is an example of the second upper limit index value of the present invention, and the lower limit level position set for the second storage container 14 is an example of the second lower limit index value of the present invention. Likewise, in the second embodiment, the first interface level upper limit condition is an example of the first storage upper limit condition of the present invention, the first interface level lower limit condition is an example of the first storage lower limit condition of the present invention, the second interface level upper limit condition is an example of the second storage upper limit condition of the present invention, and the second interface level lower limit condition is an example of the second storage lower limit condition of the present invention.

In the second embodiment, when at least one of the third interface level upper limit condition and the fourth interface level lower limit condition is met, the control unit 74 switches the filling permission state of the second extractant filling switching device 43 from the third filling permission state to the fourth filling permission state, switches the delivery permission state of the second extractant delivery switching device 44 from the fourth delivery permission state to the third delivery permission state, switches the lead-in permission state of the second delivery fluid lead-in switching device 49 from the fourth lead-in permission state to the third lead-in permission state, and switches the discharge permission state of the second delivery fluid discharge switching device 50 from the third discharge permission state to the fourth discharge permission state, the third interface level tipper limit condition being a condition that the level position of the interface detected by the third storage container level meter 68 reaches the upper limit level position set for the third storage container 16, and the fourth interface level lower limit condition being a condition that the level position of the interface detected by the fourth storage container level meter 69 reaches the lower limit level position set for the fourth storage container 18. On the other hand, when at least one of the third interface level lower limit condition and the fourth interface level upper limit condition is met, the control unit 74 switches the filling permission state of the second extractant filling switching device 43 from the fourth filling permission state to the third filling permission state, switches the delivery permission state of the second extractant delivery switching device 44 from the third delivery permission state to the fourth delivery permission state, switches the lead-in permission state of the second delivery fluid lead-in switching device 49 from the third lead-in permission state to the fourth lead-in permission state, and switches the discharge permission state of the second delivery fluid discharge switching device 50 from the fourth discharge permission state to the third discharge permission state, the third interface level lower limit condition being a condition that the level position of the interface detected by the third storage container level meter 68 reaches the lower limit level position set for the third storage container 16, and the fourth interface level upper limit condition being a condition that the level position of the interface detected by the fourth storage container level meter 69 reaches the upper limit level position set for the fourth storage container 18.

In the second embodiment, the upper limit level position set for the third storage container 16 is an example of the first upper limit index value of the present invention, the lower limit level position set for the third storage container 16 is an example of the first lower limit index value of the present invention, the upper limit level position set for the fourth storage container 18 is an example of the second upper limit index value of the present invention, and the lower limit level position set for the fourth storage container 18 is an example of the second lower limit index value of the present invention. In the second embodiment, the third interface level upper limit condition is an example of the first storage upper limit condition of the present invention, the third interface level lower limit condition is an example of the first storage lower limit condition of the present invention, the fourth interface level upper limit condition is an example of the second storage upper limit condition of the present invention, and the fourth interface level lower limit condition is an example of the second storage lower limit condition of the present invention.

Except the above-described process, processes carried out by the extraction method of the second embodiment are the same as those carried out by the extraction method of the first embodiment.

(Effects by Second Embodiment)

In the interaction system 1 according to the second embodiment, the extractant stored in each of the first to fourth storage containers 12, 14, 16, and 18 is pushed out by the pressure of the delivery fluid supplied from the delivery fluid tank 20 and is sent to the corresponding processing channels 100 of the first and second interaction units 94 and 95. This eliminates the need of pumps for sending the extractant stored in each of the first to fourth storage containers 12, 14, 16, and 18 to the corresponding processing channels 100 of the first and second interaction units 94 and 95. The number of pumps included in the interaction system 1, therefore, can be reduced. Hence costs required for pump maintenance can be reduced.

In the interaction system 1 according to the second embodiment, the delivery fluid is supplied from the delivery fluid tank 20 of the delivery fluid supply unit 19, the delivery fluid tank 20 being a common delivery tank, to each of the first to fourth storage containers 12, 14, 16 and 18, where the extractants stored in the first to fourth storage containers 12, 14, 16 and 18 are sent out, respectively. Therefore, even if the number of processing units included in the interaction system 1 increases and, consequently, the number of storage containers increases, an increase in the number of delivery fluid supply units 19 is prevented. The interaction system 1 becoming complicated in configuration, therefore, can be prevented.

Except the above-described effect, effects by the second embodiment are the same as the effects by the first embodiment.

### Third Embodiment

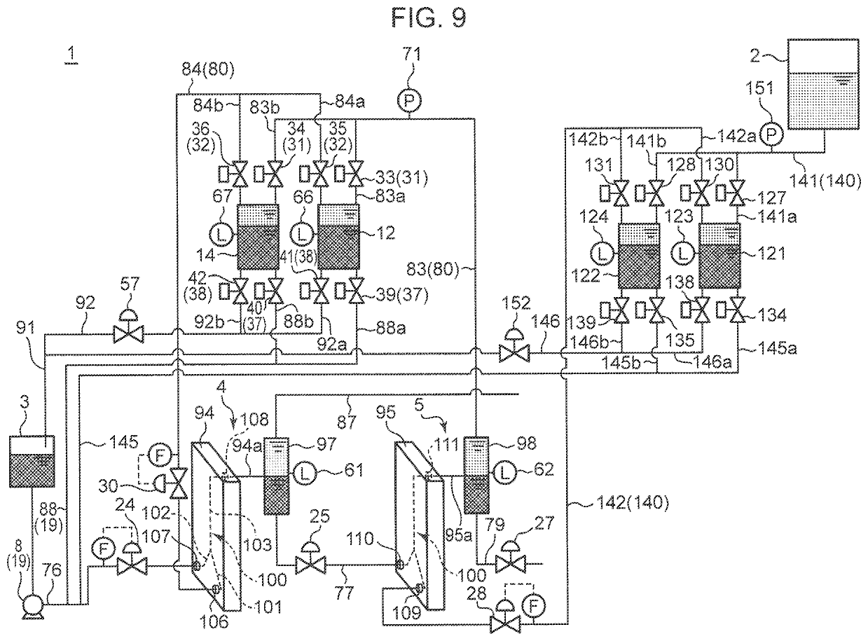

An interaction system 1 according to a third embodiment of the present invention will hereinafter be described with reference to FIG. 9. FIG. 9 depicts an overall configuration of the interaction system 1 according to the third embodiment.

The interaction system 1 according to the third embodiment includes two stages of processing units, i.e., the first processing unit 4 and the second processing unit 5. The interaction system 1 according to the third embodiment is configured such that a delivery mechanism having a first supply container 121 and a second supply container 122, the delivery mechanism being provided in place of the extractant supply pumps, sends the extractant supplied from the extractant tank 2, to the processing channel 100 of the second interaction unit 95 of the second processing unit 5, which is a final stage processing unit.

Specifically, the interaction system 1 according to the third embodiment includes the first supply container 121, the second supply container 122, a first supply container level meter 123, and a second supply container level meter 124, a first inflow switching valve 127, a second inflow switching valve 128, a first outflow switching valve 130, a second outflow switching valve 131, a first lead-in switching valve 134, a second lead-in switching valve 135, a first discharge switching valve 138, a second discharge switching valve 139, an extractant supply path 140, a delivery pipe 145, a supply pressure sensor 151, and a supply pressure control valve 152.

The extractant supply path 40 leads the extractant from the extractant tank 2 to the processing channel 100 of the second interaction unit 95 of the second processing unit 5, i.e., the final stage processing unit. This extractant supply path 140 is an example of a first fluid supply path according to the present invention. The extractant supply path 140 has an upstream side pipe 141 and a downstream side pipe 142.

The upstream side pipe 141 is connected to the extractant tank 2. A downstream side part of the upstream side pipe 141 branches into a first connection pipe 141a and a second connection pipe 141b. An upstream side part of the downstream side pipe 142 branches into a first connection pipe 142a and a second connection pipe 142b. A downstream side part of the downstream side pipe 142 is connected to the first inlet 109 of the second interaction unit 95.

The first supply container 121 and the second supply container 122 are provided on the extractant supply path 140. The first supply container 121 and the second supply container 122 each store the extractant led out from the extractant tank 2 into the upstream side pipe 141 of the extractant supply path 140. The first supply container 121 and the second supply container 122 are connected respectively to the extractant tank 2 via the upstream side pipe 141. Specifically, the first connection pipe 141a of the upstream side pipe 141 is connected to the top of the first supply container 121, and the second connection pipe 141b of the upstream side pipe 141 is connected to the top of the second supply container 122.

The first supply container 121 and the second supply container 122 are connected respectively to the first inlet 109 of the second interaction unit 95, via the downstream side pipe 142. Specifically, the first connection pipe 142a of the downstream side pipe 142 is connected to the top of the first supply container 121, and the second connection pipe 142b of the downstream side pipe 142 is connected to the top of the first supply container 121. In this configuration, the extractant stored in each of the first supply container 121 and the second supply container 122 can be supplied to the first inlet 109 of the second interaction unit 95 through the downstream side pipe 142.

The delivery pipe 145 leads the raw material, which is supplied from the raw material supply pump 8 of the delivery fluid supply unit 19, to the first supply container 121 and to the second supply container 122 so that the extractant stored in each of the first supply container 121 and the second supply container 122 is pushed out by the raw material liquid as the delivery fluid to flow through the downstream side pipe 142 of the extractant supply path 140 into the processing channel 100 (first inlet 109) of the second interaction unit 95 of the second processing unit 5, i.e., the final stage processing unit.

Specifically, the first supply container 121 and the second supply container 122 is connected to a part of raw material supply pipe 76 that is on the downstream side to the raw material supply pump 8 (side to which the raw material supply pump 8 sends out the raw material liquid), via the delivery pipe 145. In this configuration, part of the raw material liquid sent out by the raw material supply pump 8 can be supplied as the delivery fluid, to the first supply container 121 and to the second supply container 122 through the delivery pipe 145.

More specifically, the delivery pipe 145 is connected to the part of raw material supply pipe 76 that is on the downstream side to the raw material supply pump 8, and branches into a first pipe 145a and a second pipe 145b in the middle of extension of the delivery pipe 145. The first pipe 145a is connected to the bottom of the first supply container 121. The second pipe 145b is connected to the bottom of the second supply container 1′22.

In the third embodiment, the delivery fluid recovery pipe 91 branches into the first recovery pipe 92 and a third recovery pipe 146. The third recovery pipe 146 branches into a first supply container connection pipe 146a connected to the first supply container 121 and into a second supply container connection pipe 146b connected to the second supply container 122. The first supply container connection pipe 146a is connected to the bottom of the first supply container 121. The second supply container connection pipe 146b is connected to the bottom of the second supply container 122. In this configuration, from the first supply container 121 and the second supply container 122, the raw material liquid as the delivery fluid can be sent to the raw material tank 3, that is, recovered by the raw material tank 3 through the third recovery pipe 146.

The first connection pipe 141a of the upstream side pipe 141 is provided with the first inflow switching valve 127. The second connection pipe 141b of the upstream side pipe 141 is provided with the second inflow switching valve 128. On a part of upstream side pipe 141 that is further upstream than the part where the upstream side pipe 141 branches into the first connection pipe 141a and the second connection pipe 141b (a part closer to the extractant tank 2), the supply pressure sensor 151 is provided.

The first connection pipe 142a of the downstream side pipe 142 is provided with the first outflow switching valve 130. The second connection pipe 142b of the downstream side pipe 142 is provided with the second outflow switching valve 131.

The first pipe 145a of the delivery pipe 145 is provided with the first lead-in switching valve 134. The second pipe 145b of the delivery pipe 145 is provided with the second lead-in switching valve 135.

The first supply container connection pipe 146a of the third recovery pipe 146 is provided with the first discharge switching valve 138. The second supply container connection pipe 146b of the third recovery pipe 146 is provided with the second discharge switching valve 139. On a part of third recovery pipe 146 that is further downstream than the part where the third recovery pipe 146 branches into the first supply container connection pipe 146a and the second supply container connection pipe 146b (a part closer to the raw material tank 3), the supply pressure control valve 152 is provided.

The interaction system 1 according to the third embodiment includes a control unit (not shown) similar to the control unit 74 of the interaction system 1 according to the first embodiment. The control unit controls the first inflow switching valve 127, the second inflow switching valve 128, the first outflow switching valve 130, the second outflow switching valve 131, the first lead-in switching valve 134, the second lead-in switching valve 135, the first discharge switching valve 138, and the second discharge switching valve 139, in the same manner as controlling the first extractant inflow switching valve 33, the second extractant inflow switching valve 34, the first extractant outflow switching valve 35, the second extractant outflow switching valve 36, the first lead-in switching valve 39, the second lead-in switching valve 40, the first discharge switching valve 41, and the second discharge switching valve 42.

Specifically, when at least one of a first interface level upper limit condition and a second interface level lower limit condition is met, the control unit puts the first inflow switching valve 127, the second outflow switching valve 131, the second lead-in switching valve 135, and the first discharge switching valve 138 into an open state, while puts the second inflow switching valve 128, the first outflow switching valve 130, the first lead-in switching valve 134, and the second discharge switching valve 139 into a closed state, the first interface level upper limit condition being a condition that the level position of an interface between the extractant and the raw material liquid in the first supply container 121 reaches an upper limit level position set for the first supply container 121, the level position being detected by the first supply container level meter 123, and the second interface level lower limit condition being a condition that the level position of an interface between the extractant and the raw material liquid in the second supply container 122 reaches a lower limit level position set for the second supply container 122, the level position being detected by the second supply container level meter 124. As a result, the extractant led out from the extractant tank 2 into the upstream side pipe 141 flows through the first connection pipe 141a into the first supply container 121 to fill it and the raw material liquid as the delivery fluid is discharged from the first supply container 121 to the first supply container connection pipe 146a of the third recovery pipe 146 and is sent to the raw material tank 3, that is, collected by the raw material tank 3 through the delivery fluid recovery pipe 91, and at the same time, the raw material liquid as the delivery fluid is led through the second pipe 145b of the delivery pipe 145 into the second supply container 122, and by the raw material liquid, the extractant stored in the second supply container 122 is pushed out toward the second connection pipe 142b of the downstream side pipe 142 and is sent to the processing channel 100 of the second interaction unit 95.

When at least one of a first interface level lower limit condition and a second interface level upper limit condition is met, the control unit also puts the second inflow switching valve 128, the first outflow switching valve 130, the first lead-in switching valve 134, and the second discharge switching valve 139 into the open state, while puts the first inflow switching valve 127, the second outflow switching valve 131, the second lead-in switching valve 135, and the first discharge switching valve 138 into the closed state, the first interface level lower limit condition being a condition that the level position of an interface between the extractant and the raw material liquid in the first supply container 121 reaches a lower limit level position set for the first supply container 121, the level position being detected by the first supply container level meter 123, and the second interface level upper limit condition being a condition that the level position of an interface between the extractant and the raw material liquid in the second supply container 122 reaches an upper limit level position set for the second supply container 122, the level position being detected by the second supply container level meter 124. As a result, the extractant led out from the extractant tank 2 into the upstream side pipe 141 flows through the second connection pipe 141b into the second supply container 122 to fill it and the raw material liquid as the delivery fluid is discharged from the second supply container 122 to the second supply container connection pipe 146b of the third recovery pipe 146 and is sent to the raw material tank 3, that is, collected by the raw material tank 3 through the delivery fluid recovery pipe 91, and at the same time, the raw material liquid as the delivery fluid is led through the first pipe 145a of the delivery pipe 145 into the first supply container 121, and by the raw material liquid, the extractant stored in the first supply container 121 is pushed out toward the first connection pipe 142a of the downstream side pipe 142 and is sent to the processing channel 100 of the second interaction unit 95.

The control unit controls the supply pressure control valve 152, based on a pressure detected by the supply pressure sensor 151, thereby adjusting the pressure of the raw material liquid discharged from the first supply container 121 and the second supply container 122 to the third recovery pipe 146, that is, respective internal pressures of the first supply container 121 and the pressure in the second supply container 122, to a given pressure.

The configuration of the interaction system 1 according to the third embodiment is the same as the configuration of the interaction system 1 according to the first embodiment, except the above-described constituent elements.

(Effects by Third Embodiment)

According to the interaction system 1 of the third embodiment, the extractant is sent from the extractant tank 2 to the processing channel 100 of the second interaction unit 95 of the second processing unit 5, i.e., the final stage processing unit, using the pressure of the raw material liquid as the delivery fluid supplied from the raw material supply pump 8. Specifically, the extractant, which is led out from the extractant tank 2 into the upstream side pipe 141 of the extractant supply path 140 and is stored in each of the first and second supply containers 121 and 122, is pushed out by the raw material liquid as the delivery fluid, which is sent from the raw material supply pump 8 to each of the first and second supply containers 121 and 122 through the delivery pipe 145, and is sent to the processing channel 100 of the second interaction unit 95. The interaction system 1 of the third embodiment, therefore, can dispense with an extractant supply pump for sending the extractant from the extractant tank 2 to the processing channel 100 of the second interaction unit 95 of the second processing unit 5, i.e., the final stage processing unit. Hence the number of pumps included in the interaction system 1 can be reduced, and therefore costs required for pump maintenance can be further reduced.

Except the above-described effect, effects by the third embodiment are the same as the effects by the first embodiment.

### Modifications

The interaction system according to the present invention is not necessarily limited to those systems described in the above embodiments. The following configurations, for example, may be adopted as configurations of the interaction system according to the present invention.

The number of stages of the processing units included in the interaction systemic according to the present invention may be 2 or any number more than 2. The interaction systems of the first and second embodiments each include three stages of processing units, i.e., the first to third processing units. These interaction systems, however, may each include two stages of the processing units or four or more stages of processing units. The interaction system of the third embodiment includes two stages of processing units, i.e., the first and second processing units. This interaction system, however, may include three or more stages of processing units.

The delivery mechanism having the storage container for sending the extractant from the separation container of the succeeding stage processing unit to the processing channel of the interaction unit of the preceding stage processing unit may be provided on each of the extractant feeding paths that are provided in accordance with the number of stages of processing units included in the interaction system.

In the interaction system of the second embodiment, the delivery fluid may be a liquid incompatible with the extractant. In this case, the delivery fluid supply source may include a tank that holds the delivery fluid of a liquid form, and a pump for sending the delivery fluid held in the tank to each storage container.

In the interaction system of the second embodiment, when the delivery fluid is a gas, the delivery fluid supply source may be composed of a tank that holds the delivery fluid, and a compressor that compressively pressurizes the delivery fluid supplied from the tank.

The first fluid and the second fluid according to the present invention are not necessarily limited to liquids, and one or both of the first fluid and the second fluid may be a gas.

The interaction between the first fluid and the second fluid according to the present invention is not necessarily limited to the extraction treatment of extracting a specific component from the raw material liquid and causing the specific component to move into the extractant. The concept of the interaction according to the present invention includes, for example, an absorption process of causing an absorption liquid to absorb a specific component in a certain subject gas or a process of bringing two fluids into contact with each other to cause them to chemically react. The interaction system according to the present invention can be applied also to execution of such processes. In the case of the absorption process, the absorption liquid corresponds to the first fluid of the present invention and the subject gas corresponds to the second fluid of the present invention. In the case of the chemical reaction, one of the two fluids that chemically react with each other corresponds to the first fluid of the present invention, and the other of the same corresponds to the second fluid of the present invention.

The preceding stage processing unit of the present invention is not necessarily limited to the processing unit that precedes the succeeding stage processing unit by one stage in the order of flow of the second fluid through multiple stages of processing units included in the interaction system, and may be a processing unit that precedes the succeeding stage processing unit by two or more stages.

### Summary of Embodiments and Modifications

The embodiments and the modifications are summarized as folios.

An interaction system according to the embodiments and the modifications is an interaction system that causes an interaction between a first fluid and a second fluid. The interaction system includes: a first fluid tank that stores the first fluid; a second fluid tank that stores the second fluid; a plurality of processing units each including an interaction unit and a separation container, the interaction unit having a processing channel therein, the processing channel allowing the first fluid and the second fluid to flow therethrough so as to cause the first fluid and the second fluid to come in contact with each other to make an interaction, the separation container receiving a mixture fluid of the first fluid and the second fluid discharged from the processing channel to retain the mixture fluid, to thereby cause the mixture fluid to separate into the first fluid and the second fluid, the plurality of processing units being configured such that the second fluid flows from the second fluid tank into the plurality of processing units in predetermined order, the separation container of the each of the plurality of processing units being connected to the processing channel of the interaction unit of the corresponding processing unit that is next in flow order so as to allow the second fluid separated in the separation container of each of the plurality of processing units to flow into the processing channel of the interaction unit of the processing unit that is next in flow order to the each of the plurality of processing units; a first fluid feeding path that leads the first fluid separated in the separation container of a succeeding stage processing unit from the separation container of the succeeding stage processing unit to the processing channel of the interaction unit of a preceding stage processing unit, the succeeding stage processing unit being the processing unit that succeeds a first stage processing unit that is the processing unit coming first in the flow order, the preceding stage processing unit being the processing unit that precedes the succeeding stage processing unit in the flow order; a storage container provided on the first fluid feeding path to store the first fluid led from the separation container of the succeeding stage processing unit to the first fluid feeding path; and a delivery fluid supply unit connected to the storage container and configured to supply a delivery fluid to the storage container so that the first fluid stored in the storage container is pushed out by the delivery fluid to flow through the first fluid feeding path into the processing channel of the interaction unit of the preceding stage processing unit.

In this interaction system, the first fluid separated in the separation container of the succeeding stage processing unit is temporarily stored in the storage container provided on the first fluid feeding path, and the first fluid stored in the storage container is pushed out by the delivery fluid, which is supplied from the delivery fluid supply unit, and is sent to the processing channel of the interaction unit of the preceding stage processing unit. The first fluid separated in the separation container of the succeeding stage processing unit and sent from the separation container to the processing channel of the interaction unit of the preceding stage processing unit, therefore, does not flow through a pump. Hence, according to the interaction system, the number of pumps through which the fluid separated in the separation container of the succeeding stage processing unit and sent to the processing channel of the preceding stage processing unit can be reduced.

The interaction system may further include a second fluid supply pipe that connects the second fluid tank to the processing channel of the interaction unit of the first stage processing unit so as to lead the second fluid from the second fluid tank to the processing channel of the interaction unit of the first stage processing unit, and the delivery fluid supply unit may include: a second fluid delivery pump provided on the second fluid supply pipe and configured to send out the second fluid to cause the second fluid to flow from the second fluid tank to the processing channel of the interaction unit of the first stage processing unit; and a delivery fluid supply pipe that connects a part of the second fluid supply pipe to the storage container so as to lead part of the second fluid as the delivery fluid to the storage container, the part of the second fluid being the second fluid sent out by the second fluid delivery pump, the part of the second fluid supply pipe being on a downstream side to the second fluid delivery pump.

According to this configuration, part of the second fluid sent out by the second fluid delivery pump is used as the delivery fluid, and the first fluid stored in the storage container is pushed out by using a pressure for sending out the second fluid, the pressure being applied by the second fluid delivery pump. This configuration eliminates the need of separately providing a pump that creates a pressure for sending out the first fluid, which is led out from the separation container of the succeeding stage processing unit and stored in the storage container, to the processing channel of the interaction unit of the preceding stage processing unit. The number of pumps included in the interaction system, therefore, can be reduced. Hence costs required for pump maintenance can be reduced.

The delivery fluid supply unit may include: a delivery fluid tank in which the delivery fluid is stored with a pressure higher than an internal pressure of the storage container; and a delivery fluid supply pipe that connects the delivery fluid tank to the storage container so as to lead the delivery fluid stored in the delivery fluid tank, from the delivery fluid tank to the storage container.

According to this configuration, the first fluid stored in the storage container is pushed out by the pressure of the delivery fluid supplied from the delivery fluid tank, and is sent to the processing channel of the interaction unit of the preceding stage processing unit. This configuration eliminates the need of separately providing a pump for sending out the first fluid, which is led out from the separation container of the succeeding stage processing unit into the first fluid feeding path and stored in the storage container, to the processing channel of the interaction unit of the preceding stage processing unit. The number of pumps included in the interaction system, therefore, can be reduced. Hence costs required for pump maintenance can be reduced.

It is preferable that the plurality of processing units include three or more processing units, and that the three or more processing units include: a plurality of succeeding stage processing units as the succeeding stage processing units; and a plurality of preceding stage processing units as the preceding stage processing units, the plurality of preceding stage processing units corresponding respectively to the plurality of succeeding stage processing units. It is also preferable that the interaction system includes: a plurality of first fluid feeding paths as the first fluid feeding path, the plurality of first fluid feeding paths each leading the first fluid from each of the separation containers of the plurality of succeeding stage processing units to each of the processing channels of the interaction units of the preceding stage processing units corresponding respectively to the plurality of succeeding stage processing units; and a plurality of storage containers as the storage container, the plurality of storage containers being provided respectively on the plurality of first fluid feeding paths, and the delivery fluid supply unit is connected to each of the plurality of storage containers so as to supply the delivery fluid to each of the plurality of storage containers.

According to this configuration, the delivery fluid is supplied from the common delivery fluid supply unit to each of the plurality of storage containers, and the first fluid stored in the plurality of storage containers is sent to the processing channel of the interaction unit of the preceding stage processing unit corresponding to the plurality of storage containers. Thus, even if the number of processing units included in the interaction system increases and, consequently, the number of storage containers increases, an increase in the number of delivery fluid supply units is prevented, and therefore, the interaction system's becoming complicated in configuration is prevented.

It is preferable that the interaction system further includes a first storage container and a second storage container as the storage container, the first storage container and the second storage container each being capable of storing the first fluid led out from the separation container of the succeeding stage processing unit into the first fluid feeding path, that the first fluid feeding path includes: a lead-in side pipe that connects the separation container of the succeeding stage processing unit to the first storage container and to the second storage container so as to lead the first fluid flowing out of the separation container of the succeeding stage processing unit, to the first storage container and to the second storage container; and a delivery side pipe that connects each of the first storage container and the second storage container to the processing channel of the interaction unit of the preceding stage processing unit so as to lead the first fluid stored in the first storage container and the first fluid stored in the second storage container, to the processing channel of the interaction unit of the preceding stage processing unit, and that the delivery fluid supply unit is connected to the first storage container and to the second storage container so as to be capable of supplying the delivery fluid to the first storage container and to the second storage container. It is also preferable that the interaction system further includes: a first fluid filling switching device provided on the lead-in side pipe, the first fluid filling switching device being configured to be capable of s itching between a first filling permission state and a second filling permission state, the first filling permission state being a state of permitting a led-out first fluid to be led into the first storage container to fill it and preventing the led-out first fluid from being led into the second storage container, the led-out first fluid being the first fluid led out from the separation container of the succeeding stage processing unit to the lead-in side pipe, the second filling permission state being a state of permitting the led-out first fluid to be led into the second storage container to fill it and preventing the led-out first fluid from being led into the first storage container; a first fluid delivery switching device provided on the delivery side pipe, the first fluid delivery switching device being configured to be capable of switching between a first delivery permission state and a second delivery permission state, the first delivery permission state being a state of permitting the first fluid to be sent from the first storage container to the delivery side pipe and preventing the first fluid from being sent from the second storage container to the led-out side pipe, the second delivery permission state being a state of permitting the first fluid to be sent from the second storage container to the delivery side pipe and preventing the first fluid from being sent from the first storage container to the delivery side pipe; a delivery fluid lead-in switching device configured to be capable of switching between a first lead-in permission state and a second lead-in permission state, the first lead-in permission state being a state of permitting a supplied delivery fluid to be led into the first storage container and preventing the supplied delivery fluid from being led into the second storage container, the supplied delivery fluid being the delivery fluid supplied by the delivery fluid supply unit, the second lead-in permission state being a state of permitting the supplied delivery fluid to be led into the second storage container and preventing the supplied delivery fluid from being led into the first storage container; and a delivery fluid discharge switching device configured to be capable of switching between a first discharge permission state and a second discharge permission state, the first discharge permission state being a state of permitting the delivery fluid to be discharged from the first storage container and preventing the delivery fluid from being discharged from the second storage container, the second discharge permission state being a state of permitting the delivery fluid to be discharged from the second storage container and preventing the delivery fluid from being discharged from the first storage container.

According to this configuration, by switching respective states of the first fluid filling switching device, the first fluid delivery switching device, the delivery fluid lead-in switching device, and the delivery fluid discharge switching device, while the first fluid is sent from one storage container that is one of the first storage container and the second storage container to the processing channel of the interaction unit of the preceding stage processing unit, the first fluid is led into the other storage container of the first storage container and the second storage container to fill them. At a point of time at which the storage amount of the first fluid in the one storage container, from which the first fluid is sent out, reduces to a lower limit or the storage amount of the first fluid in the other storage container, into which the first fluid is fed, reaches an upper limit, the first fluid is sent from the other storage container to the processing channel of the interaction unit of the preceding stage processing unit as the first fluid is led into the one storage container to fill it. In this manner, a storage container into which the first fluid is fed and a storage container that sends the first fluid to the processing channel of the interaction unit of the preceding stage processing unit can be switched to each other. Thus, a state in which the first fluid is fed into the first storage container as the first fluid is sent out of the second storage container and a state in which the first fluid is fed into the second storage container as the first fluid is sent out of the first storage container can be switched to each other in every a certain period. After the storage amount of the first fluid in a container that is one of the first storage container and the second storage container decreases, therefore, the interaction can be carried out continuously without interrupting it by waiting the container's being refilled with the first fluid.

It is preferable in this case that the interaction system further includes: a first storage detection unit that detects a first storage index value that is an index value indicative of an a mount of the first fluid stored in the first storage container; a second storage detection unit that detects a second storage index value that is an index value indicative of an amount of the first fluid stored in the second storage container; and a control unit that carries out control for switching a state of the first fluid filling switching device between the first filling permission state and the second filling permission state, control for switching a state of the first fluid delivery switching device between the first delivery permission state and the second delivery permission state, control for switching a state of the delivery fluid lead-in switching device between the first lead-in permission state and the second lead-in permission state, and control for switching a state of the delivery fluid discharge switching device between the first discharge permission state and the second discharge permission state. It is also preferable that when at least one of a first storage upper limit condition and a second storage lower limit condition is met, the control unit switches the state of the first fluid filling switching device from the first filling permission state to the second filling permission state, switches the state of the first fluid delivery switching device from the second delivery permission state to the first delivery permission state, switches the state of the delivery fluid lead-in switching device from the second lead-in permission state to the first lead-in permission state, and switches the state of the delivery fluid discharge switching device from the first discharge permission state to the second discharge permission state, the first storage upper limit condition being a condition that the first storage index value detected by the first storage detection unit reaches a first upper limit index value corresponding to an upper limit to a storage amount of the first fluid, the upper limit being set for the first storage container, the second storage lower limit condition being a condition that the second storage index value detected by the second storage detection unit reaches a second lower limit index value corresponding to a lower limit to a storage amount of the first fluid, the lower limit being set for the second storage container; on the other hand, when at least one of a first storage lower limit condition and a second storage upper limit condition is met, the control unit switches the state of the first fluid filling switching device from the second filling permission state to the first filling permission state, switches the state of the first fluid delivery switching device from the first delivery permission state to the second delivery permission state, switches the state of the delivery fluid lead-in switching device from the first lead-in permission state to the second lead-in permission state, and switches the state of the delivery fluid discharge switching device from the second discharge permission state to the first discharge permission state, the first storage lower limit condition being a condition that the first storage index value detected by the first storage detection unit reaches a first lower limit index value corresponding to a lower limit to a storage amount of the first fluid, the lower limit being set for the first storage container, the second storage upper limit condition being a condition that the second storage index value detected by the second storage detection unit reaches a second upper limit index value corresponding to an upper limit to a storage amount of the first fluid, the upper limit being set for the second storage container.

According to this configuration, a state in which the first fluid is fed into the first storage container as the first fluid is sent out from the second storage container to the processing channel of the interaction unit of the preceding stage processing unit and a state in which the first fluid is fed into the second storage container as the first fluid is sent out from the first storage container to the processing channel of the interaction unit of the preceding stage processing unit can be switched automatically to each other. Specifically, according to this configuration, when the first fluid is fed into the first storage container to increase the storage amount of the first fluid in the first storage container and consequently the first storage index value detected by the first storage detection unit reaches the first upper limit index value, or, as the first fluid is fed into the first storage container, the first fluid is sent from the second storage container to the processing channel of the interaction unit of the preceding stage processing unit to reduce the storage amount of the first fluid in the second storage container and consequently the second storage index value detected by the second storage detection unit reaches the second lower limit index value, the control unit switches a state of the first fluid filling switching device, from the first filling permission state to the second filling permission state, switches the state of the first fluid delivery switching device, from the second delivery permission state to the first delivery permission state, switch the state of the delivery fluid lead-in switching device, from the second lead-in permission state to the first lead-in permission state, and switch the state of the delivery fluid discharge switching device, from the first discharge permission state to the second discharge permission state. This automatically leads to a state in which the first fluid is fed into the second storage container as the delivery fluid is discharged from the second storage container and, at the same time, the delivery fluid is led into the first storage container as, by the delivery fluid led in, the first fluid is sent from the first storage container to the processing channel of the interaction unit of the preceding stage processing unit. Meanwhile, when the first fluid is fed into the second storage container to increase the storage amount of the first fluid in the second storage container and consequently the second storage index value detected by the second storage detection unit reaches the second upper limit index value, or, as the first fluid is fed into the second storage container, the first fluid is sent from the first storage container to the processing channel of the interaction unit of the preceding stage processing unit to reduce the storage amount of the first fluid in the first storage container and consequently the first storage index value detected by the first storage detection unit reaches the first lower limit index value, the control unit switches a, state of the first fluid filling switching device, from the second filling permission state to the first filling permission state, switches a state of the first fluid delivery switching device, from the first delivery permission state to the second delivery permission state, switch a state of the delivery fluid lead-in switching device, from the first lead-in permission state to the second lead-in permission state, and switch a state of the delivery fluid discharge switching device, from the second discharge permission state to the first discharge permission state. This automatically leads to a state in which the first fluid is fed into the first storage container as the delivery fluid is discharged from the first storage container and, at the same time, the delivery fluid is led into the second storage container as, by the delivery fluid led in, the first fluid is sent from the second storage container to the processing channel of the interaction unit of the preceding stage processing unit.

It is preferable that the interaction system further includes: a first fluid supply path that leads the first fluid from the first fluid tank to the processing channel of the interaction unit of a final stage processing unit that is the processing unit that comes last in the flow order; a supply container provided on the first fluid supply path to store the first fluid led out from the first fluid tank to the first fluid supply path; and a delivery pipe that leads the delivery fluid supplied from the delivery fluid supply unit, to the supply container so that the first fluid stored in the supply container is pushed out by the delivery fluid to flow through the first fluid supply path into the processing channel of the interaction unit of the final stage processing unit.

According to this configuration, the first fluid is sent from the first fluid tank to the processing channel of the interaction unit of the final stage processing unit, using the delivery fluid supplied from the delivery fluid supply unit. Specifically, the first fluid, which is led out from the first fluid tank into the first fluid supply path and stored in the supply container, is pushed out by the delivery fluid, which is led out from the delivery fluid supply unit to the supply container through the delivery pipe, and is sent to the processing channel of the interaction unit of the final stage processing unit. This configuration, therefore, does not need the first fluid supply pump, which is included in the conventional interaction system for sending the first fluid from the first fluid tank to the processing channel of the interaction unit of the final stage processing unit. The number of pumps included in the interaction system, therefore, can be further reduced, and costs required for pump maintenance can be reduced.

As described above, according to the embodiments and the modifications, the interaction system is provided in which, on the path that leads the fluid separated in the separation container of the succeeding stage processing unit to the processing channel of the processing unit of the preceding stage processing unit, the fluid is sent out by a means different from a pump, to the processing channel of the processing unit of the preceding stage processing unit.

1. An interaction system that causes an interaction between a first fluid and a second fluid, the interaction system comprising:
a first fluid tank that stores the first fluid;
a second fluid tank that stores the second fluid;
a plurality of processing units each including an interaction unit and a separation container, the interaction unit having a processing channel therein, the processing channel allowing the first fluid and the second fluid to flow therethrough so as to cause the first fluid and the second fluid to come in contact with each other to make an interaction, the separation container receiving a mixture fluid of the first fluid and the second fluid discharged from the processing channel to retain the mixture fluid, to thereby cause the mixture fluid to separate into the first fluid and the second fluid, the plurality of processing units being configured such that the second fluid flows from the second fluid tank into the plurality of processing units in predetermined order, the separation container of the each of the plurality of processing units being connected to the processing channel of the interaction unit of the corresponding processing unit that is next in flow order so as to allow the second fluid separated in the separation container of each of the plurality of processing units to flow into the processing channel of the interaction unit of the processing unit that is next in flow order to the each of the plurality of processing units;
a first fluid feeding path that leads the first fluid separated in the separation container of a succeeding stage processing unit from the separation container of the succeeding stage processing unit to the processing channel of the interaction unit of a preceding stage processing unit, the succeeding stage processing unit being the processing unit that succeeds a first stage processing unit that is the processing unit coming first in the flow order, the preceding stage processing unit being the processing unit that precedes the succeeding stage processing unit in the flow order;
a storage container provided on the first fluid feeding path to store the first fluid led from the separation container of the succeeding stage processing unit to the first fluid feeding path; and
a delivery fluid supply unit connected to the storage container and configured to supply a delivery fluid to the storage container so that the first fluid stored in the storage container is pushed out by the delivery fluid to flow through the first fluid feeding path into the processing channel of the interaction unit of the preceding stage processing unit.

2. The interaction system according to claim 1, further comprising a second fluid supply pipe that connects the second fluid tank to the processing channel of the interaction unit of the first stage processing unit so as to lead the second fluid from, the second fluid tank to the processing channel of the interaction unit of the first stage processing unit,
wherein the delivery fluid supply unit includes:
a second fluid delivery pump provided on the second fluid supply pipe and configured to send out the second fluid to cause the second fluid to flow from the second fluid tank to the processing channel of the interaction unit of the first stage processing unit; and
a delivery fluid supply pipe that connects a part of the second fluid supply pipe to the storage container so as to lead part of the second fluid as the delivery fluid to the storage container, the part of the second fluid being the second fluid sent out by the second fluid delivery pump, the part of the second fluid supply pipe being on a downstream side to the second fluid delivery pump.

3. The interaction system according to claim 1, wherein
the delivery fluid supply unit includes:
a delivery fluid tank in which the delivery fluid is stored with a pressure higher than an internal pressure of the storage container; and
a delivery fluid supply pipe that connects the delivery fluid tank to the storage container so as to lead the delivery fluid stored in the delivery fluid tank, from the delivery fluid tank to the storage container.

4. The interaction system according to claim 1, wherein
the plurality of processing units include three or more processing units,
the three or more processing units include: a plurality of succeeding stage processing units as the succeeding stage processing units; and a plurality of preceding stage processing units as the preceding stage processing units, the plurality of preceding stage processing units corresponding respectively to the plurality of succeeding stage processing units,
the interaction system comprises:
a plurality of first fluid feeding paths as the first fluid feeding path, the plurality of first fluid feeding paths each leading the first fluid from each of the separation containers of the plurality of succeeding stage processing units to each of the processing channels of the interaction units of the preceding stage processing units corresponding respectively to the plurality of succeeding stage processing units; and
a plurality of storage containers as the storage container, the plurality of storage containers being provided respectively on the plurality of first fluid feeding paths, and
the delivery fluid supply unit is connected to each of the plurality of storage containers so as to supply the delivery fluid to each of the plurality of storage containers.

5. The interaction system according to claim 1, comprising a first storage container and a second storage container as the storage container, the first storage container and the second storage container each being capable of storing the first fluid led out from the separation container of the succeeding stage processing unit into the first fluid feeding path,
wherein the first fluid feeding path includes:
a lead-in side pipe that connects the separation container of the succeeding stage processing unit to the first storage container and to the second storage container so as to lead the first fluid flowing out of the separation container of the succeeding stage processing unit, to the first storage container and to the second storage container; and
a delivery side pipe that connects each of the first storage container and the second storage container to the processing channel of the interaction unit of the preceding stage processing unit so as to lead the first fluid stored in the first storage container and the first fluid stored in the second storage container, to the processing channel of the interaction unit of the preceding stage processing unit,
the delivery fluid supply unit is connected to the first storage container and to the second storage container so as to be capable of supplying the delivery fluid to the first storage container and to the second storage container, and
the interaction system further comprises:
a first fluid filling switching device provided on the lead-in side pipe, the first fluid filling switching device being configured to be capable of switching between a first filling permission state and a second filling permission state, the first filling permission state being a state of permitting a led-out first fluid to be led into the first storage container to fill it and preventing the led-out first fluid from being led into the second storage container, the led-out first fluid being the first fluid led out from the separation container of the succeeding stage processing unit to the lead-in side pipe, the second filling permission state being a state of permitting the led-out first fluid to be led into the second storage container to fill it and preventing the led-out first fluid from being led into the first storage container;
a first fluid delivery switching device provided on the delivery side pipe, the first fluid delivery switching device being configured to be capable of switching between a first delivery permission state and a second delivery permission state, the first delivery permission state being a state of permitting the first fluid to be sent from the first storage container to the delivery side pipe and preventing the first fluid from being sent from the second storage container to the led-out side pipe, the second delivery permission state being a state of permitting the first fluid to be sent from the second storage container to the delivery side pipe and preventing the first fluid from being sent from the first storage container to the delivery side pipe;
a delivery fluid lead-in switching device configured to be capable of switching between a first lead-in permission state and a second lead-in permission state, the first lead-in permission state being a state of permitting a supplied delivery fluid to be led into the first storage container and preventing the supplied delivery fluid from being led into the second storage container, the supplied delivery fluid being the delivery fluid supplied by the delivery fluid supply unit, the second lead-in permission state being a state of permitting the supplied delivery fluid to be led into the second storage container and preventing the supplied delivery fluid from being led into the first storage container; and
a delivery fluid discharge switching device configured to be capable of switching between a first discharge permission state and a second discharge permission state, the first discharge permission state being a state of permitting the delivery fluid to be discharged from the first storage container and preventing the delivery fluid from being discharged from the second storage container, the second discharge permission state being a state of permitting the delivery fluid to be discharged from the second storage container and preventing the delivery fluid from being discharged from the first storage container.

6. The interaction system according to claim 5, further comprising:
a first storage detection unit that detects a first storage index value that is an index value indicative of an amount of the first fluid stored in the first storage container;
a second storage detection unit that detects a second storage index value that is an index value indicative of an amount of the first fluid stored in the second storage container; and
a control unit that carries out control for switching a state of the first fluid filling switching device between the first filling permission state and the second filling permission state, control for switching a state of the first fluid delivery switching device between the first delivery permission state and the second delivery permission state, control for switching a state of the delivery fluid lead-in switching device between the first lead-in permission state and the second lead-in permission state, and control for switching a state of the delivery fluid discharge switching device between the first discharge permission state and the second discharge permission state,
wherein when at least one of a first storage upper limit condition and a second storage lower limit condition is met, the control unit switches the state of the first fluid filling switching device from the first filling permission state to the second filling permission state, switches the state of the first fluid delivery switching device from the second delivery permission state to the first delivery permission state, switches the state of the delivery fluid lead-in switching device from the second lead-in permission state to the first lead-in permission state, and switches the state of the delivery fluid discharge switching device from the first discharge permission state to the second discharge permission state, the first storage upper limit condition being a condition that the first storage index value detected by the first storage detection unit reaches a first upper limit index value corresponding to an upper limit to a storage amount of the first fluid, the upper limit being set for the first storage container, the second storage lower limit condition being a condition that the second storage index value detected by the second storage detection unit reaches a second lower limit index value corresponding to a lower limit to a storage amount of the first fluid, the lower limit being set for the second storage container; on the other hand, when at least one of a first storage lower limit condition and a second storage upper limit condition is met, the control unit switches the state of the first fluid filling switching device from the second filling permission state to the first filling permission state, switches the state of the first fluid delivery switching device from the first delivery permission state to the second delivery permission state, switches the state of the delivery fluid lead-in switching device from the first lead-in permission state to the second lead-in permission state, and switches the state of the delivery fluid discharge switching device from the second discharge permission state to the first discharge permission state, the first storage lower limit condition being a condition that the first storage index value detected by the first storage detection unit reaches a first lower limit index value corresponding to a lower limit to a storage amount of the first fluid, the lower limit being set for the first storage container, the second storage upper limit condition being a condition that the second storage index value detected by the second storage detection unit reaches a second upper limit index value corresponding to an upper limit to a storage amount of the first fluid, the upper limit being set for the second storage container.

7. The interaction system according to claim 1, further comprising:
a first fluid supply path that leads the first fluid from the first fluid tank to the processing channel of the interaction unit of a final stage processing unit that is the processing unit that comes last in the flow order;
a supply container provided on the first fluid supply path to store the first fluid led out from the first fluid tank to the first fluid supply path; and
a delivery pipe that leads the delivery fluid supplied from the delivery fluid supply unit, to the supply container so that the first fluid stored in the supply container is pushed out by the delivery fluid to flow through the first fluid supply path into the processing channel of the interaction unit of the final stage processing unit.
